(19) United States
(12) Patent Application Publication
(10) Pub. No.: US 2009/0046996 A1
(43) Pub. Date: Feb. 19, 2009

(54) IMAGE SYNTHESIS DEVICE

(75) Inventor: Makoto Harada, Lawrenceville, NJ (US)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/813,802

(22) PCT Filed: Dec. 26, 2005
(86) PCT No.: PCT/JP2005/023806

§ 371 Date: Jul. 12, 2007

(30) Foreign Application Priority Data
Jan. 18, 2005 (JP) 2005-010482

(51) Int. Cl. H04N 5/93

(52) U.S. Cl. 386/124; 386/E05.028

(57) ABSTRACT

An image synthesis device is provided which can synthesize and display graphics, video and so on without giving the viewer a sense of discomfort.

An image synthesis device which synthesizes graphics and video, which includes a graphics data holding unit which holds graphics data; a video data holding unit which holds video data; a transparency obtainment unit which obtains from a user a specification for a transparency which is specified at a ratio at which graphics and video are synthesized; and a synthesis unit which synthesizes the graphics data held in said graphics data holding unit and the video data held in said video data holding unit according to the obtained transparency, and outputs the synthesized data.

### TECHNICAL FIELD

The present invention relates to a digital television and so on and in particular to a digital television and so on which alpha synthesizes and displays graphics, video and so on.

### BACKGROUND ART

Generally in digital television, a graphics plane which displays images, text and so on, as well as a video plane which displays video defined by an MPEG2 stream and the like are defined, layered atop each other and displayed. Here, planes are actually an abstract conceptual region which holds an on-screen display (OSD) or an output image such as a graphics buffer or a video buffer. These planes are each held in the layered order and generally, the graphics plane is in the foreground and the video plane is in the background. Note that in the DVB-MHP standard (formally, the ETSI TS 101 812 DVB-MHP standard 1.0.2), the graphics plane, the video plane and the background plane are defined and in the logical layering order, the foreground is defined as the graphics plane, the middle as the video plane and the background as the background plane. One method for layering is generally known as alpha blending, which is performed by using an alpha (α) value which indicates transparency. The alpha value indicates at what ratio pixels corresponding to the graphics and video plane must be synthesized, and indicates that 0.0 is completely transparent and that 1.0 is completely non-transparent.

The structure of each plane prescribed in the DVB-MHP standard is shown in FIG. 38. Here, the graphics, video and background, which are stored respectively in a graphics plane 3501, a video plane 3502 and a background plane 3503, are alpha-synthesized by a synthesis unit 3511 and an image of these planes is displayed in a screen 3504.

Many technologies related to alpha blending among each of the video, graphics, background and other planes have been proposed (for example, “the image output device” and so on disclosed in the Patent Document 1). Also, technologies have been proposed which realize the effect of showing an image such that it stands out, by using an alpha value replacement unit which replaces the alpha values stored by each plane for a uniformly specified alpha value, and by changing the time and alpha value (for example, “the image synthesis device and method” and so on disclosed in Patent Document 2).

Patent Reference 1: Japanese Patent Application Publication No. 2003-348447 Publication

Patent Reference 2: Japanese Patent Application Publication No. 2003-283935 Publication

### DISCLOSURE OF INVENTION

Problems that Invention is to Solve

However, approaches for defining the alpha value for alpha blending differ by the standards of each country or by each type of digital television. In the DVB-MHP standard, in the graphics plane, each pixel holds a color value as well as an alpha value, and alpha blending is performed between different planes using the alpha value. Also, in the “image synthesis device” disclosed in the Patent Document 2 above, each plane holds a respective alpha value, and the alpha value with the highest priority value is used in alpha blending between planes.

However, there is the problem that the synthesis based on the alpha value decided in this way is not necessarily limited to synthesis demanded by a user who views digital television and so on. For example, in DVB-MHP, in a situation in which both graphics and video are outputted, the situation occurs in which, even though the user wants to view both the graphics and the video, the user cannot view the video because the video is covered by the graphics plane due to a non-transparent alpha value being set as the alpha value used in synthesis. As a specific example, when the user views baseball on a digital television, a graphic is displayed which notifies the user that mail has been received, which obscures important additional information showing the batter count, the out count and so on, thereby making the user uncomfortable.

Thus, the present invention is realized in consideration of this problem and takes as an object providing a digital television and image synthesis method which can synthesize and display graphics and video without making the user uncomfortable.

### Means to Solve the Problems

In order to achieve the object above, the digital television according to the present invention is a digital television which synthesizes graphics and video generated by an application, including: a graphics data holding unit which holds a value set according to the graphics data and a request from the application, the value being an alpha value that indicates a synthesis ratio for the graphics data; a video data holding unit which holds video data; a transparency obtainment unit which obtains from a viewer of the digital television a specification for a transparency which is specified at a ratio at which graphics data and video data are synthesized; and a synthesis unit which synthesizes the graphics data held in the graphics data holding unit and the video data held in the video data holding unit according to the obtained transparency, and to output the synthesized data as a ratio of: a correction coefficient for the alpha value, which is equal to the transparency obtained by the transparency obtainment unit, and a corrected alpha value obtained by multiplying the alpha value by the correction coefficient; and a display unit which displays the graphics data and the video data synthesized by the synthesis unit.

Thus, for example even when graphics are transmitted from the broadcaster at a setting at which the graphics are completely transparent, the user can view both the graphics and the video simultaneously without a feeling of discomfort since the graphics and video are synthesized according to the transparency specified by the user.

Furthermore, when the alpha value is originally set at 100% adjustment, can be performed in which the preferences of the user and the preferences of the producer are reflected since the user can increase and decrease the transparency by only a preferred ratio.

Also, the digital television further includes a downloading unit which downloads a program from outside; wherein the alpha value may be stored in the graphics holding unit according to a first program downloaded by the downloading unit. Then, the obtainment of the transparency by the transparency obtainment unit may be performed by executing a second program downloaded by the downloading unit. Thus, on the transmitting side, the alpha value of the graphics can be set and permission for the adjustment can be controlled since corrections are performed on the settings of the alpha value for the graphics or on the alpha value.

Also, the synthesis unit optimally synthesizes according to the Porter-Duff rule. Thus, an alpha blending which accurately reflects the user's transparency can be achieved by well-known methods.

Also, the digital television further includes a background data holding unit which holds background data that shows a background image; and the synthesis unit optimally also synthesizes the background data held in the background data holding unit, in addition to the graphics data and the video data. Thus, a digital television according to the DVB-MHP standard can be achieved.

Also, the digital television may include a plurality of at least one of the graphics data holding unit, the video data holding unit, and the background data holding unit. Thus, a digital television compatible with a highly functional display device which includes plural planes of the same concept is realized.

Note that the present invention may be realized not only as the kind of digital television above but also as an image synthesis method which includes the characteristic units included in the image synthesis device as steps, as a program including these steps, and as a recording media such as a computer-readable CD-ROM on which such a program is recorded.

### EFFECTS OF THE INVENTION

According to the present invention, graphics and video are alpha-synthesized according to the desired transparency set by the user, and thereby the malfunction in which video and the like is obscured by the graphics is avoided and the user can continue to view the video without a feeling of discomfort.

Also, since the alpha value of the graphics can be determined using a downloaded program and adjustments made to the alpha value, the preferences of the producer for synthesized display of graphics and video can be reflected and it is possible to create a program compatible with many different preferences.

### BRIEF DESCRIPTION OF DRAWINGS

FIG. 1 is a structural diagram of a cable television system according to the present invention;

FIG. 2 is a diagram which shows an example of usage of a frequency region used in communication between the head end and the terminal device in the cable television system;

FIG. 3 is a diagram which shows a detailed usage example in the OOB frequency region;

FIG. 4 is a diagram that shows a usage example in the In-band frequency band;

FIG. 5 is a structural diagram of the terminal device;

FIG. 6 is an exterior diagram of the terminal device;

FIG. 7 is a structural diagram of POD hardware;

FIG. 8 is a structural diagram of a program held by the POD;

FIG. 9 is a structural diagram of the packet defined by the MPEG standard;

FIG. 10 is a diagram which shows an example of the MPEG2 transport stream;

FIG. 11 is a diagram which shows an example of an external view when the input unit is configured on the front panel;

FIG. 12 is a structural diagram of the display synthesis unit;

FIG. 13 is a structural diagram of the program held by the terminal device;

FIG. 14 is a diagram which shows a display example of EPG;

FIG. 15 is a diagram which shows an example of information stored in the second storage unit;

FIG. 16 is a diagram which shows an example of information held in the first storage unit 511;

FIG. 17 is a schematic diagram which shows an example of PAT, as defined by the MPEG2 standard;

FIG. 18 is a schematic diagram which shows a detailed example of PMT as defined by the MPEG2 standard;

FIG. 19 is a schematic diagram which shows an example of AIT content, as defined by the DVB-MHP standard;

FIG. 20 is a schematic diagram which shows an example of the file system transmitted in DSMCC protocol;

FIG. 21 is a schematic diagram which shows an example of XAIT content;

FIG. 22 is a diagram which shows an example of information held in a second storage unit;

FIG. 23 is a diagram which shows a list example of the Java™ program according to EPG;

FIG. 24 is a diagram which shows a display example of the Mail Java™ program;

FIG. 25 is a diagram which shows a display example of the Mail Java™ program;

FIG. 26 is a diagram which shows a display example of the Mail Java™ program;

FIG. 27 is a diagram which shows a display example of the Mail Java™ program;

FIG. 28 is a diagram which shows a display example of the video;

FIG. 29 is a diagram which shows an example of a synthesized display of video and graphics using the mail Java™ program;

FIG. 30 is a diagram which shows an example of the synthesized display of video and graphics using the mail Java™ program;

FIG. 31 is a flowchart which displays a start-up sequence of a menu image;

FIG. 32 is a diagram which shows a display example of the menu image;

FIG. 33 is a diagram which shows a display example of the transparency adjustment image;

FIG. 34 is a flowchart which shows the transparency settings and the sequence of reflection on the screen;

FIG. 35 is a diagram which shows an example in which a button for adjusting the transparency is installed in the front panel and the remote control of the terminal device;

FIG. 36 is a diagram which shows another example of the transparency adjustment image;

FIGS. 37 (A) and (B) show other examples of the image synthesis device according to the present invention;

FIG. 38 is a diagram which shows the structure of each plane in the DVB-MHP standard.

### NUMERICAL REFERENCES

101 Head end

111 Terminal device A

112 Terminal device B

113 Terminal device C

500 Terminal device

501 QAM demodulation unit

502 QPSK demodulation unit

503 QPSK modulation unit

504 POD

505 TS decoder

506 Audio decoder

507 Speaker

508 Video decoder

509 Display

510 First storage unit

511 Second storage unit

512 ROM

513 Input unit

514 CPU

### BEST MODE FOR CARRYING OUT THE INVENTION

Below, an embodiment of the present invention is explained in detail using the drawings.

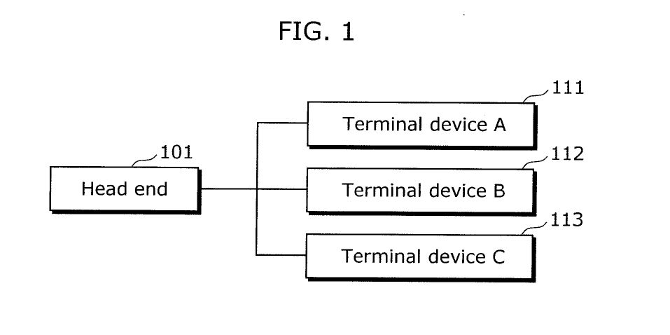

FIG. 1 is a block diagram which illustrates the relationship between devices which comprise the cable system in the embodiment of the present invention. This cable system is a system which distributes a television broadcast on cable, and is made up of a head end 101 and three terminal devices: A111, B112 and C113. Note that in this example, three terminal devices are connected to one head end 101, however an arbitrary amount of terminal devices may be connected to a head end 101.

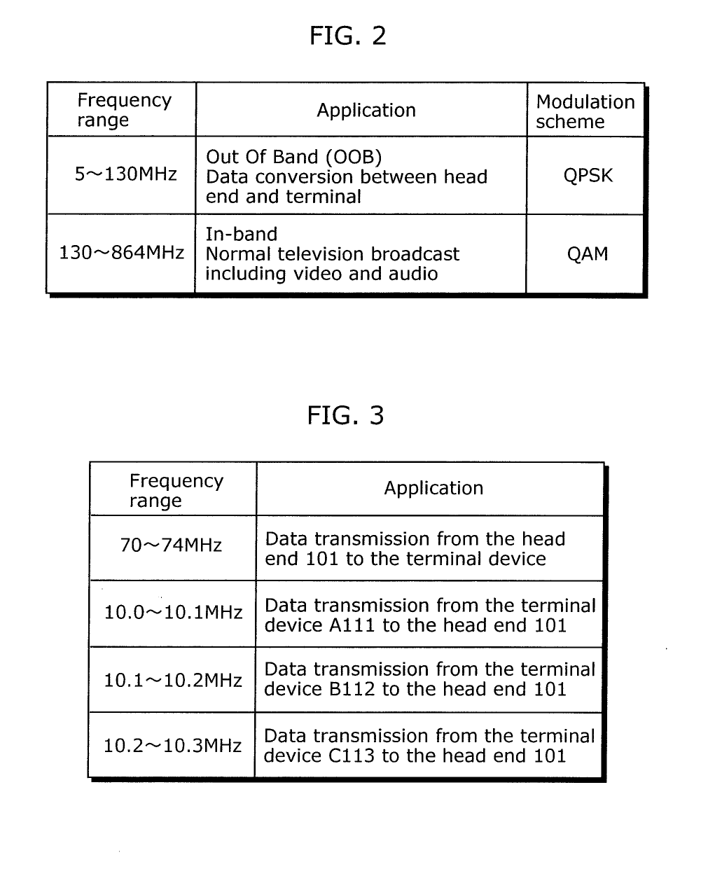

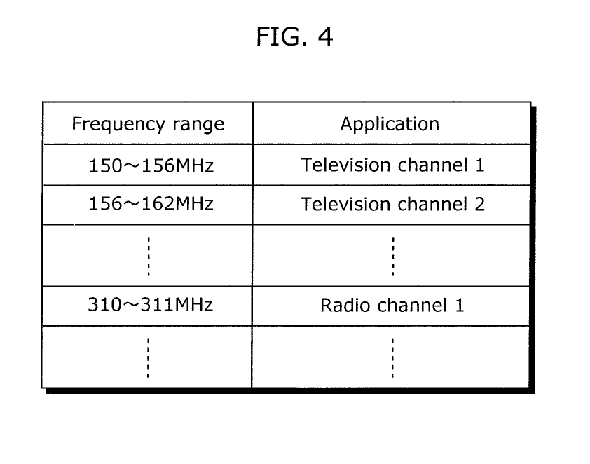

The head end 101 transmits a broadcast signal such as video/audio/data to terminal devices and receives a data transmission from the terminal devices. In order to realize this configuration, the frequency region used in transmission between the head end 101 and the terminal device A111, the terminal device B112 and the terminal device C113 is divided and used. FIG. 2 is a table which shows an example of a split in the frequency region. The frequency region is split into two types: Out of Band (below, “OOB”) and In-Band. OOB is allocated for 5 to 130 MHz and is used mainly in data relay between the head end 101, the terminal device A111, the terminal device B112 and the terminal device C113. In-band is allocated for 130 MHz to 864 MHz, and is used mainly for broadcast channels which include video and audio. In OOB, a QPSK modulation scheme is used and in In-Band, a QAM64 modulation scheme is used. Modulation scheme technology is well-known technology with little relation to the present invention and thus a detailed explanation is omitted. FIG. 3 is a more detailed example of the use of the OOB frequency region. 70 MHz to 74 Mhz is used in data transmission from the head end 101, and the same data is received from all of the terminal device A111, the terminal device B112, the terminal device C113 and the head end 101. Meanwhile, 10.0 MHz to 10.1 MHz is used in data transmission from the terminal All to the head end 101, 10.1 MHz to 10.2 MHz is used in data transmission from the terminal device B112 to the head end 101 and 10.2 MHz to 10.3 MHz is used in data transmission from the terminal device C113 to the head end 101. Thus, data belonging to each terminal device can be transmitted from each of the terminal device A111, the terminal device B112 and the terminal device C113 to the head end 101. FIG. 4 is an example of use of the In-Band frequency band. 150 to 156 MHz and 156 to 162 MHz are allocated respectively to television channel 1 and television channel 2 and subsequently television channels are distributed in 6 MHz intervals. After 310 MHz, channels are allocated to the radio channels every 1 MHz. Each of these channels may be used for analogue broadcasts or for digital broadcasts. In digital broadcasting, data is transmitted in a transport packet format based on the MPEG2 specification and data for each type of data broadcast can be transmitted in addition to audio and video.

In order to transmit an appropriate broadcast signal to the frequency region, a QPSK modulation unit and a QAM modulation unit are included in the head end 101. Also, in order to receive data from the terminal device, a QPSK demodulation device is included. Also, the head end 101 includes a variety of constituent elements related to these modulation units and demodulation units. However, a detailed explanation is omitted since the present invention is mainly related to a terminal device.

The terminal device A111, the terminal device B112 and the terminal device C113 are digital televisions and the like which receive the broadcast signal from the head end 101 and reproduce the signal. Also, data in each of the terminal devices is transmitted to the head end 101. The three terminal devices include the same structure in the present invention.

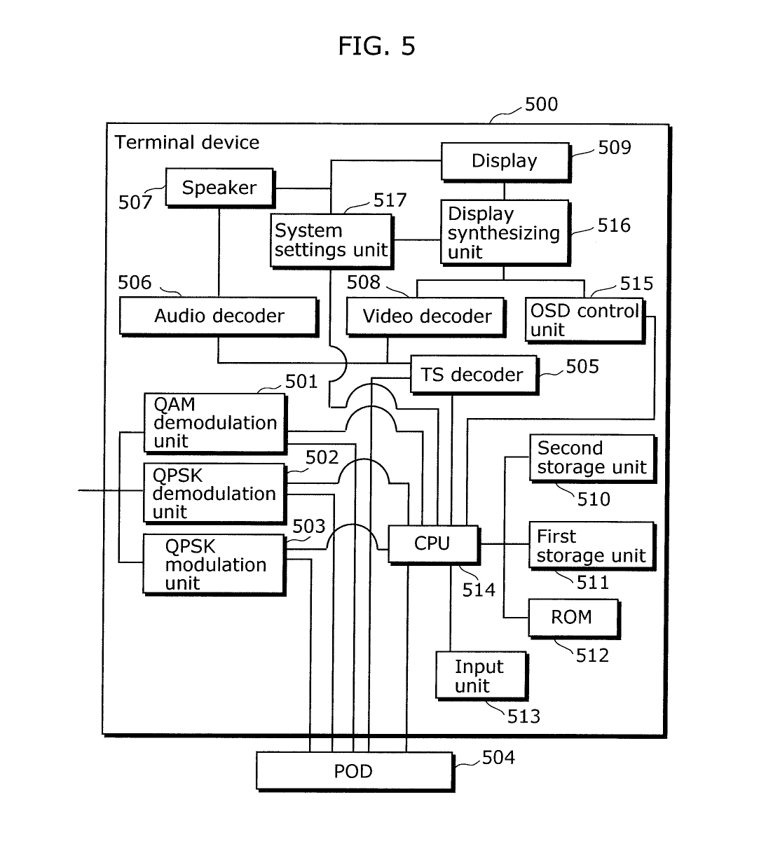

FIG. 5 is a block diagram which shows the hardware structure of the terminal devices A111, B112 and C113 (below, simply written as “terminal device 500”) which are shown in FIG. 1. The terminal device 500 is made up of a QAM demodulation unit 501, a QPSK demodulation unit 502, a QPSK modulation unit 503, a TS decoder 505, an audio decoder 506, a speaker 507, a video decoder 508, a display 509, a second storage unit 510, a first storage unit 511, a ROM 512, an input unit 513, a CPU 514, an OSD control unit 515, a display synthesis unit 516 and a system settings unit 517. Note that the terminal device 500 includes a detachable POD 504.

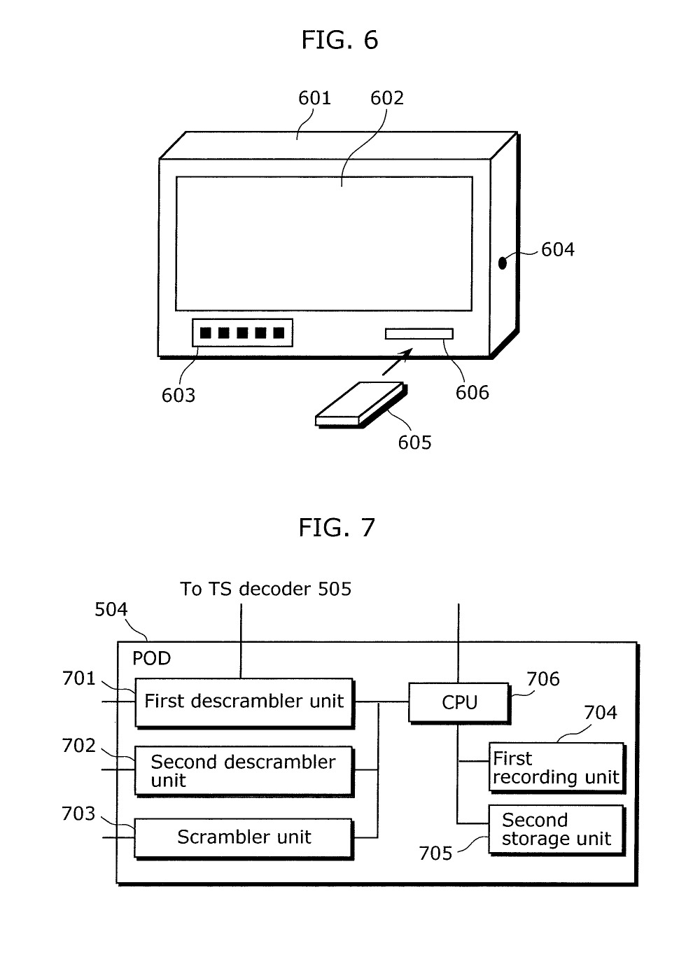

FIG. 6 is an example of an exterior view of the terminal device 500 as a flat-screen television. The cabinet 601 is a flat-screen television cabinet, which includes all of the constituent elements of the terminal device 500, except for POD 504. The display 602 corresponds to the display 509 in FIG. 5. The front panel 603 is made up of buttons and corresponds to the input unit 513 in FIG. 5. The signal input terminal 604 is a terminal which connects cable lines for performing transmission and reception of the signal with the head end 101, and is connected to the QAM demodulation unit 501, the QPSK demodulation unit 502 and the QPSK demodulation unit 503 in FIG. 5. The POD card 605 corresponds to the POD504 in FIG. 5, is independent of the terminal device 500 and is detachable from the terminal device 500 via the insertion slot 606. Details related to the POD504 are written below. With reference to FIG. 5, the QAM demodulation unit 501 demodulates the signal which is QAM modulated and transmitted by the head end 101 and delivers the signal to the POD 504 according to tuning information which includes a signal specified by the CPU 514.

The QPSK demodulation unit 502 demodulates the signal which is QPSK modulated and transmitted by the head end 101 and delivers the signal to the POD 504 according to the tuning information, which includes a frequency specified from the CPU 514.

The QPSK modulation unit 503 QPSK modulates the signal delivered from the POD 504, and transmits the signal to the head end 101 according to modulation information which includes the frequency specified by the CPU 514.

The POD 504 is detachable from the terminal device 500, as shown in FIG. 6. The connection interface of the terminal device 500 and the POD 504 is defined by the Open Cable™ HOST-POD Interface Standard (OC-SP-HOSTPOD-IF-I12-030210) and by specifications referenced in this specification. Below, the details are omitted and only the portion relevant to the present invention is explained.

FIG. 7 is a block diagram which illustrates the internal structure of the POD 504. The POD 504 is a card which decrypts the encrypted signal sent to the terminal device 500 from the head end 101 and encrypts the data sent from the terminal device 500 to the head end 101. The POD 504 is made up of a first descrambler unit 701, a second descrambler unit 702, a scrambler unit 703, a first storage unit 704, a second storage unit 705 and a CPU 706.

The first descrambler unit 701 receives the encrypted signal from the QAM demodulation unit 501 in the terminal device 500 via an instruction from the CPU 706 and performs decrypting. Thus, the decrypted signal is sent to the TS decoder 505 in the terminal device 500. Information, such as a key necessary for decryption, is supplied when necessary from the CPU 706. More specifically, the head end 101 broadcasts several pay channels. When the user purchases a pay channel, the user can view the pay channel using the first descrambler unit 701, which receives and descrambles necessary information, such as a key from the CPU 706. When necessary information such as a key is not provided, the first descrambler unit 701 does not perform descrambling and sends the received signal as-is to the TS decoder 505.

The second descrambler unit 702 receives the encrypted signal from the QAM demodulation unit 502 in the terminal device 500 via an instruction from the CPU 706 and performs decrypting. Subsequently, the decrypted data is delivered to the CPU 706.

The scrambler unit 703 encrypts the data received from the CPU 706 using an instruction from the CPU 706 and sends the data to the QPSK modulation unit 503 in the terminal device 500.

The first storage unit 704 is more specifically made up of a first recording memory which is used for temporarily saving data when the CPU 706 performs a process.

The second storage unit 705 is more specifically made up of second storage memories such as a flash ROM. The second storage unit 705 stores the program executed by the CPU 706, and is used for saving data that should not be deleted even when the power is turned OFF.

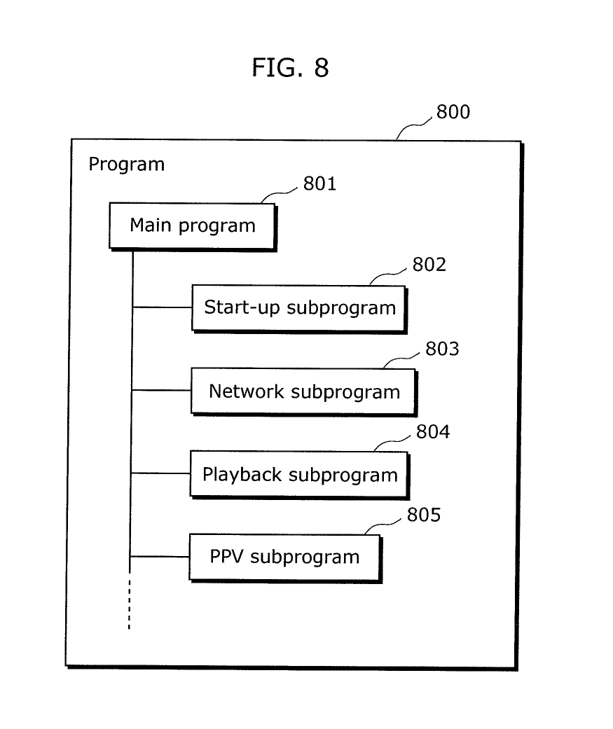

The CPU 706 executes a program which is stored by the second recording unit 705. The program is made up of subprograms. FIG. 8 is an example of the program stored by the second recording unit 705. In FIG. 8, the program 800 is made up of several subprograms such as a main program 801, a start-up subprogram 802, a network subprogram 803, a reproduction subprogram 804 and a PPV subprogram 805.

Here, PPV is an abbreviation for Pay Per View, a service in which a specific program such as a movie can be viewed for a price. When the user inputs the PIN number, the head end 101 is notified that the PIN number has been entered, the movie is descrambled and can be viewed. The user must later pay a viewing fee due to viewing the movie.

The main program 801 is a subprogram which first starts up when the CPU 706 is powered on, and controls other subprograms.

The start-up subprogram 802 is started by the main program 801 when the CPU 706 is powered on and performs information exchange and so on with the terminal device 500, as well as a start-up process. The details of the start-up process are defined in the OpenCable™ Host-POD Interface Standard (OC-SP-HOSTPOD-IF-I12-030210) and specifications referenced in the present specification. Also, a start-up process is performed which is not defined in the specifications. Below, part of the start-up process is introduced. For example, when powered on, the start-up subprogram 802 notifies the QPSK demodulation unit 502 through the CPU 514 in the terminal device 500 of the first frequency stored in the second storage unit 705. The QPSK demodulation unit 502 performs tuning at the assigned first frequency and sends the signal to the descrambler unit 702. Also, the start-up subprogram 802 supplies decrypted information such as a first key which is stored in the second storage unit 705 to the second descrambler unit 702. As a result, the second descrambler unit 702 descrambles the information and delivers it to the CPU 706, which performs the start-up subprogram 802. Thus, the start-up subprogram 802 can receive the information. In the present embodiment, the start-up subprogram 802 receives the information through the network subprogram 803. A detailed description is mentioned below.

Also, the start-up subprogram 802 notifies the QPSK demodulation unit 503 through the CPU 514 in the terminal device 500 of the second frequency stored in the second storage unit 705. The start-up subprogram 802 supplies the encrypted information stored in the second storage unit 705 to the scrambler unit 703. When the start-up subprogram 802 supplies information that must be sent to the scrambler unit 703 through the network subprogram 803, the scrambler unit 703 encrypts the data using the encrypted information supplied and supplies the encrypted information to the QPSK modulation unit 503 in the terminal device 500. The QPSK modulation unit 503 modulates the supplied encrypted information and transmits the encrypted information to the head end 101.

As a result, the start-up subprogram 802 can perform two-way communication with the head end 101 through the terminal device 500, the second descrambler unit 702, the scrambler unit 703 and the network subprogram 803.

The network subprogram 803 is a subprogram for performing two-way communication with the head end 101, which is used by the main program 801 and subprograms such as the start-up subprogram 802. More specifically, two-way communication with the head end 101 is performed using TCP/IP for other subprograms which use the network subprogram 803. TCP/IP is a well-known technology with protocols stipulated for performing information exchange between terminals; a detailed explanation is omitted. When the CPU 706 is powered on and the network subprogram 803 is started up by the start-up program 802, the network subprogram 803 notifies a Media Access Control address (abbreviated as MAC) to the head end 101 through the terminal device 500 and issues a request to obtain an IP address, the MAC being an identifier for identifying the POD 504, which is stored beforehand by the storage unit 705. The head end 101 notifies the IP address to the POD 504 through the terminal device 500 and the network subprogram 803 stores the IP address in the first storage unit 704. Subsequently, the head end 101 and the POD 504 uses the IP address as an identifier for the POD 504 and perform communication.

The reproduction subprogram 804 supplies decoded information such as a second key which is stored in the second storage unit 705 or decoded information such as a third key which is supplied by the terminal device 500 to the first descrambler unit 701; thereby the information can be descrambled. Also, the first descrambler unit 701 receives the information that the inputted signal is a PPV channel through the network subprogram 803. When the first descrambler unit 701 apprehends that the signal is the PPV channel, the PPV subprogram 805 is started up.

When the PPV subprogram 805 is started up, a message is displayed by the terminal device 500, the message prompting the user to acquire the program, and receiving the user's input. More specifically, when information is sent which must be displayed in the CPU 514 screen in the terminal device 500, the program which operates in the CPU 514 of the terminal device 500 displays a message in a display 509 of the terminal device 500. When the user inputs the PIN number through an input unit 513 in the terminal device 500, the CPU 514 in the terminal device 500 receives the PIN number and notifies the PPV subprogram 805 which operates in the CPU 706 of the POD 504. The PPV subprogram 805 transmits the received PIN number through the network subprogram 803. When the PIN number is accurate, the head end 101 notifies the PPV subprogram through the network subprogram 803 of the necessary decrypted information such as a fourth key. The PPV subprogram 805 supplies the decrypted information such as the received fourth key to the first descrambler unit 701, and the first descrambler unit 701 descrambles the inputted signal.

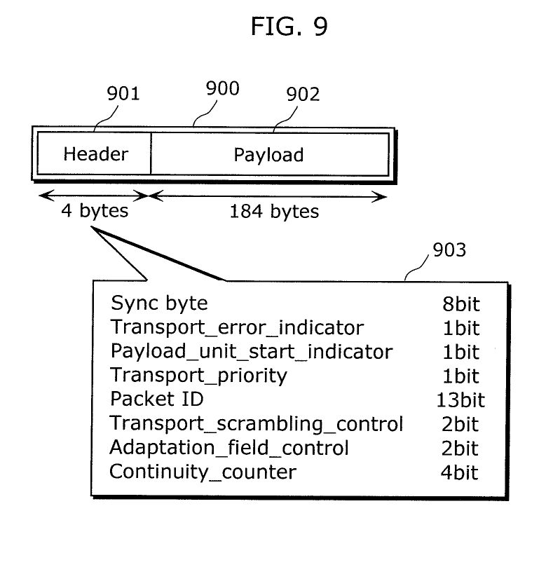

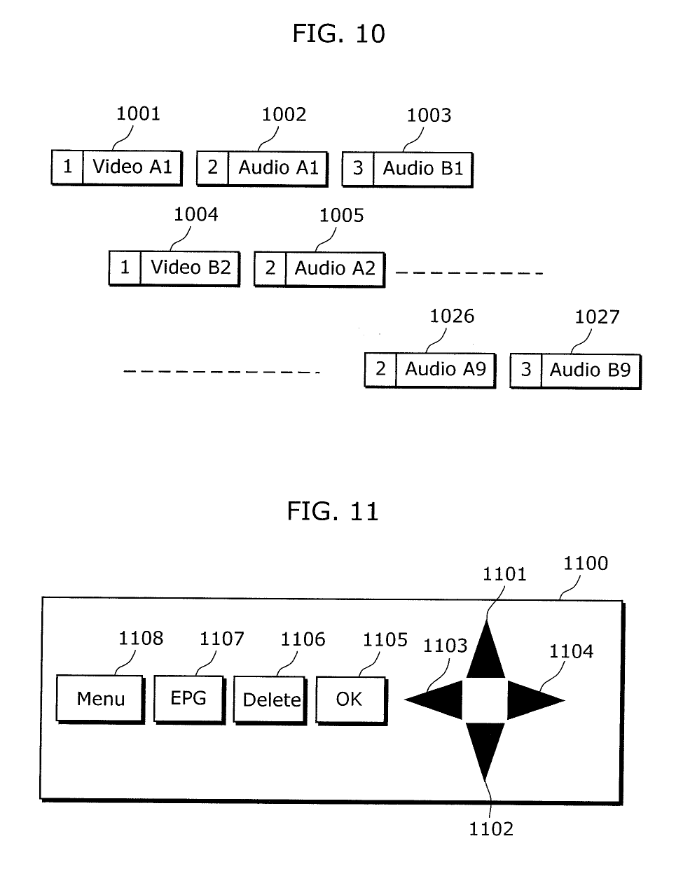

With reference to FIG. 5, the TS decoder 505 performs filtering (tuning and so on) on the signal received from the POD 504 and delivers necessary data to the audio decoder 506, the video decoder 508 and the CPU 514. Here, the signal that comes from the POD 504 is an MPEG2 transport stream. A detailed description of the MPEG2 transport stream is described in the MPEG specification ISO/IEC13818-1 and a detailed description of the present embodiment is omitted. The MPEG2 transport stream is made up of fixed length packets and a packet ID is distributed to each packet. FIG. 9 is a structural diagram of the packet. 900 is a packet composed at a fixed length of 188 bytes. The first 4 bytes of the packet store packet identification information in a header 901 and information which must be transmitted is included in the remaining 184 bytes in a payload 802. 903 is a breakdown of the header 901. A packet ID is included in the 13 bytes from the 12^{th} to the 24^{th} byte. FIG. 10 is a schematic diagram which shows rows of packets which are sent. The packet 1001 has a packet ID “1” in the header and a first piece of information of a video A is included in the payload. The packet 1002 has a packet ID “2” in the header and a first piece of information of an audio A is included in the payload. The packet 1003 has a packet ID “3” in the header and a first piece of information of an audio B is included in the payload.

The packet 1004 has a packet ID “1” in the header and a second piece of information in the video A is included in the payload, this information is a continuation of the packet 1001. In the same way, the packet 1005, 1026 and 1027 store the continuation data of another packet in the packet 1005, 1026 and 1027. In this way, when the packets have the same ID, and the content of the packet payloads is connected, continuous video and audio can be reproduced.

As shown in FIG. 10, when the CPU. 514 notifies a packet ID “1” and a “video decoder 508”, as an output destination, to the TS decoder 505, the TS decoder 505 extracts the packet ID “1” from the MPEG2 transport stream received from the POD 504 and delivers the MPEG2 transport stream to the video decoder 508. In FIG. 10, only video data is delivered to the video decoder 508. At the same time, when the CPU 514 notifies the packet ID “2” and “audio decoder 506”to the TS decoder 505, the TS decoder 505 extracts the packet ID “2” from the MPEG2 transport stream received from the POD 504 and delivers “2” to the audio decoder 506. In FIG. 10, only the audio data is delivered to the audio decoder 506.

Filtering performed by the TS decoder 505 is a process in which only the necessary packets according to the packet ID are extracted. The TS decoder 505 can simultaneously perform plural filtering processes instructed by the CPU 514.

With reference to FIG. 5, the audio decoder 506 connects the audio data which is embedded in the MPEG2 transport stream packet supplied from the TS decoder 505, performs a digital to analogue conversion, and outputs the audio data to the speaker 507.

The speaker 507 audio outputs the signal supplied from the audio decoder 506 according to a setting specified by the system settings unit 517.

The system settings unit 517 is a processing unit which applies each type of parameter setting related to audio output, display output and so on in the terminal device 500 and adjusts settings such as volume and screen brightness, contrast and display position for the speaker 507 and the display 509. Also, in the present embodiment, the system settings unit 517 instructs the display synthesis unit 516 regarding graphics transparency according to an instruction from the user.

The video decoder 508 connects the video data embedded in the MPEG2 transport stream supplied from the TS decoder 505 and outputs the video data to the display synthesis unit 516. Also, the video decoder 508 can output a still image displayed in MPEG-I and so on to the display synthesis unit 516. Note that when still images such as an MPEG-I are displayed, the still images may be displayed using a style decoder and so on other than the video decoder 508.

The OSD control unit 515 renders an image according to the rendering command in the graphics instructed from the CPU 514 and outputs the image to the display synthesis unit 516.

The display synthesis unit 516 alpha synthesizes video or the still image supplied from the video decoder 508 with graphics outputted from the OSD control unit 515, performs digital-analogue conversion and outputs the result to the display 509.

The second storage unit 510 is more specifically made up of a flash memory or a hard-disc and the like, and saves and deletes data or programs as instructed from the CPU 514. The saved data or program is referenced by the CPU 514. The saved data or program continues to be saved even when the power to the terminal device 500 is cut.

The first storage unit 511 is more specifically made up of RAM and so on, and the data or program instructed from the CPU 514 is temporarily saved or deleted. Also, the saved data or program is referenced by the CPU 514. The saved data or program is deleted when power to the terminal device 500 is cut.

The ROM 512 is a writable memory device which is more specifically made up of a ROM, a CD-ROM, a DVD or the like. The program executed by the CPU 514 is stored in the ROM 512.

The input unit 513 is more specifically made up of a front panel and a remote control and accepts input from a user. FIG. 11 shows an example of the front panel 1100 when the front panel 1100 is made up of input units 513. The front panel 1100 corresponds to the front panel unit 603 shown in FIG. 6. The front panel 1100 has 7 buttons: an upper cursor button 1101, a lower cursor button 1102, a left cursor button 1103, a right cursor button 1104, an OK button 1105, a deletion button 1106, an EPG button 1107 and a menu button 1108. When the user presses a button, the identifier of the button pressed is notified to the CPU 514.

The CPU 514 executes a program stored by the ROM 512. The QAM demodulation unit 501, the QPSK demodulation unit 502, the QPSK modulation unit 503, the POD 504, the TS decoder 505, the display 509, the second storage unit 510, the first storage unit 511 and the ROM 512 are controlled according to the instruction of the executed program.

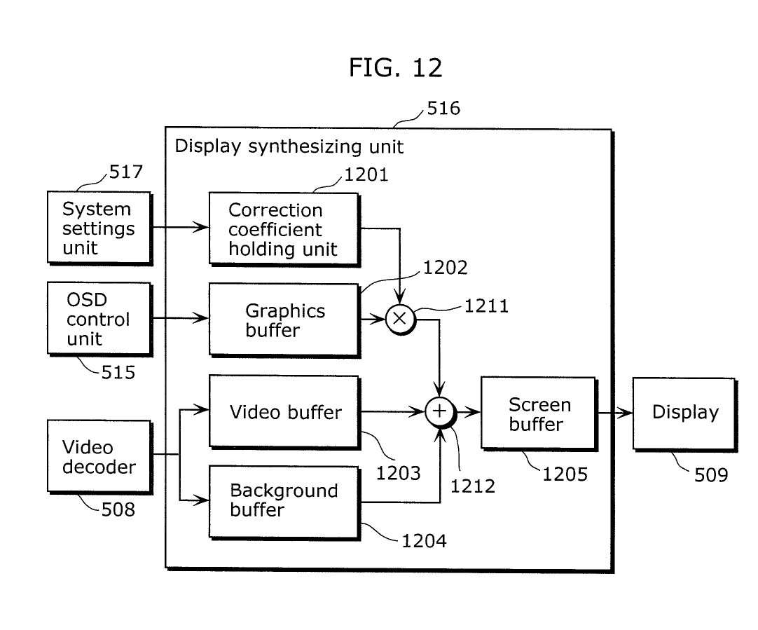

FIG. 12 is a functional block diagram which shows the detailed structure of the display synthesis unit 516 shown in FIG. 5. The display synthesis unit 516 is a processing unit which alpha synthesizes video or a still image provided by the video decoder 508 with graphics outputted from the control unit 515 according to an instruction (graphics transparency) by the system settings unit 517, and includes a correction coefficient holding unit 1201, a graphics buffer 1202, a video buffer 1203, a background buffer 1204, a screen buffer 1205, a correction unit 1211 and a synthesis unit 1212. Note that in the diagram, the system settings unit 517, the OSD control unit 515, the video decoder 508 and the display 509, which are shown in FIG. 5, are shown together.

The correction coefficient holding unit 1201 is a memory and so on which saves the transparency notified from the system settings unit 517 as a correction coefficient. Here, the correction coefficient is a coefficient which is a multiple of the alpha value, and for example is a value in the range of 0.0 to 1.0. The graphics buffer 1202 is a memory and the like which holds an image, a diagram, a letter and so on rendered by the OSD control unit 515. The graphics buffer holds an alpha value which indicates graphics data, in other words the values of each primary color R (red), G (green) and B (blue) as well as transparency for each of the pixels. The video buffer 1203 and the background buffer 1204 are memories and so on which hold video data that shows a video, and background data which shows a background image, in other words image data that is outputted from the video decoder.

Note that in the present embodiment, it is expected that there is one buffer for the graphics, the video and the background respectively, and that logically the graphics are displayed in the foreground of the display 509, video in the center and the background displayed in the rear. However, in the present embodiment, each buffer can be applied no matter the arbitrary amount of buffers nor the logical order in which they are displayed. Also, besides the graphics, video and background, the present invention can be applied even when there is a buffer used in other conceptions such as a subtitle.

The correction unit 1211 multiplies the correction coefficient held in the correction coefficient holding unit 1201 by the alpha value held in the graphics buffer 1202. When the correction coefficient is not held, the correction coefficient is calculated as 1.0. Note that the correction coefficient may be held at any value such as an 8-bit integer. Also, one correction coefficient may be prepared or plural correction coefficients may be prepared for each pixel.

The synthesis unit 1212 is a computation device and the like which multiplies the alpha value and the correction coefficient held in the graphics buffer 1202, and alpha synthesizes the video buffer 1203 and the background buffer 1204. Note that in the present embodiment, the correction coefficient and the alpha values held in each pixel of the graphics buffer 1202 are multiplied by each other, however the alpha value after correction may be found with any method such as not using each pixel in the graphics buffer 1202 and replacing all of these pixels with values of the correction coefficient (or by taking the correction coefficient as the corrected alpha value and so on). Note that alpha blending is a process of synthesis the foreground color and the background color at a certain ratio, and in the present embodiment, the calculation is performed more specifically as a calculation method which uses the Porter-Duff rule. The Porter-Duff rule is a 12-type synthesis rule which prescribes a synthesis ratio of the synthesis source color and the color to be synthesized. For example, in the SRC_OVER rule, the source color and transparency are abbreviated as Cs and As, the destination color and transparency are abbreviated as Cd and Ad, and the synthesized color is expressed as ((1−As)×Ad×Cd+As×Cs). For details of the Porter-Duff rule, please see T. Porter and T. Duff, “Compositing Digital Images” SIGGRAPH 84, 253-259. Note that the present embodiment can be applied even when another transparency calculation rule is used.

The screen buffer 1205 is a video memory, a D/A converter and so on which stores image data obtained by alpha blending in the synthesis unit 1212, performs a digital-analogue conversion on the image data and outputs the image data as a video signal to the display 509.

The display 509 is more specifically a Braun tube or a crystal display device and so on which displays the video signal from the screen buffer 1205 on the screen.

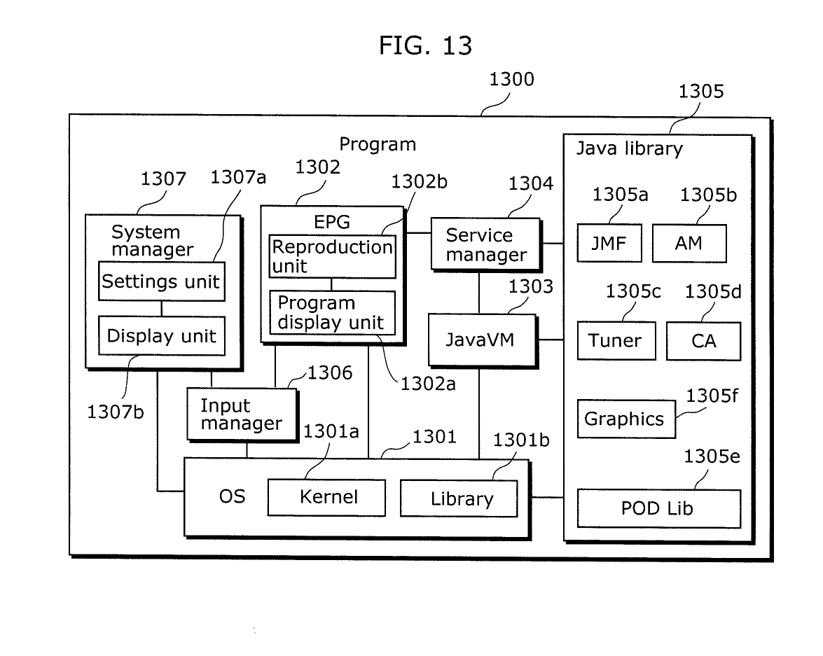

FIG. 13 is an example of a structural diagram of the program executed by the CPU 514, and stored in ROM 512. The program 1300 is made up of subprograms and more specifically of an OS 1301, an EPG 1302, a Java™ VM1303, a service manager 1304, a Java™ library 1305, an input manager 1306, and a system manager 1307.

The OS 1301 is a subprogram started up by CPU 514 when the terminal device 500 is powered on. The OS 1301 is an abbreviation for operating system, for example Linux. The OS 1301 is a generic name for well-known technology in parallel and is made up of a kernel 1301a and a library 1301b, subprograms which the OS 1301 executes in parallel; a detailed explanation is omitted. In the present embodiment, the kernel 1301a in the OS 1301 is executed as a subprogram of the EPG 1302, the Java™ VM1303, the input manager 1306 and the system manager 1307. Also, the library 1301b supplies functions for controlling the constituent elements held by the terminal device 500 to the subprograms.

As an example of a function, a tuning function is introduced below. The tuning function receives tuning information which includes a frequency from another subprogram and delivers the tuning information to the QAM demodulation unit 501. The QAM demodulation unit 501 can deliver demodulated data to the POD504 by performing a demodulation process based on the tuning information supplied. As a result, other subprograms can control the QAM demodulation device through the library 1301b.

The EPG 1302 is made up of a program schedule unit 1302a which displays a program schedule to the user and accepts input from the user through the input manager 1306, as well as a reproduction unit 1302b which performs channel selection. Below, EPG is an abbreviation for Electronic Program Guide.

The input manager 1306 accepts input from the user and distributes the input to the subprogram which requests input from the EPG 1302, the system manager 1307 and the user.

The system manager 1307 is made up of a display unit 1307a and a display unit 1307b, and each type of setting for the screen, the volume settings and so on are realized by being specified by the system settings unit 517 through the CPU 514. A detailed description is mentioned below.

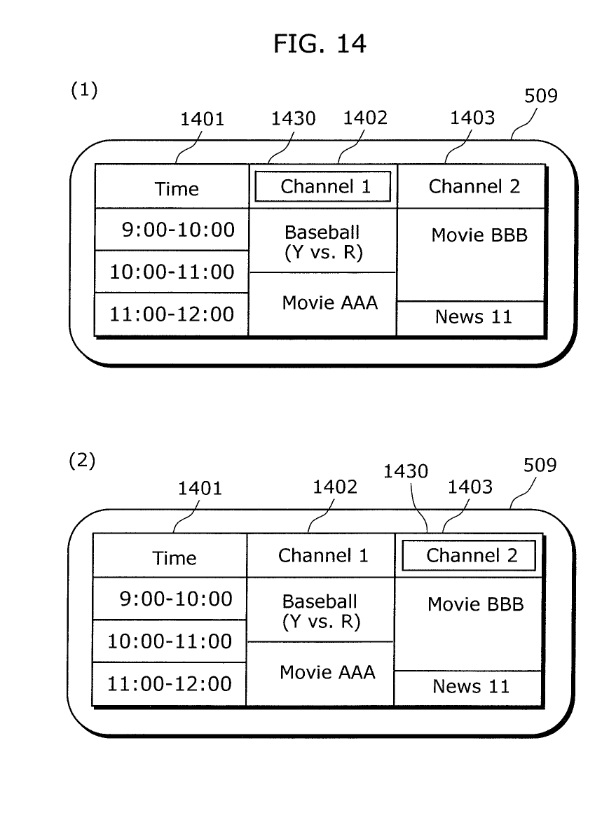

The EPG 1302 is started up by the kernel 1301a when the terminal device 500 is powered on. Inside the started-up EPG 1302, the program display unit 1302a waits for input from the user through the input unit 513 of the terminal device 500. Here, when the input unit 513 is made up of the front panel shown in FIG. 11, and the user presses down the EPG button 1107 in the input unit 513, the identifier for the EPG button is notified to the CPU 514. The program display unit 1302a in the EPG 1302, which is a subprogram operated in the CPU 514, receives the identifier and displays program information in the display 509. FIGS. 14 (1) and (2) are examples of the program schedule displayed in the display 509. As shown in FIG. 14 (1), program information is displayed in a grid in the display 509. Time information is displayed in column 1401. Channel information “Channel 1” and programs to be broadcast in the time slot according to the column 1401 is displayed in a column 1402. In “Channel 1”, the program “baseball (Y vs. R)” is broadcast from 9:00 to 10:30, and a “movie AAA” is broadcast from 10:30 to 12:00. Similar to columns 1403 and 1402, the channel name “Channel 2” and programs to be broadcast in the time slot according to the time in column 1401 are displayed. “Movie BBB” is broadcast from 9:00 to 11:00, and “news 11” is broadcast from 11:00 to 12:00. 1330 is the cursor. The cursor 1330 shifts when the user presses the left cursor 1103 and the right cursor 1104 in the front panel 1100. In the display state shown in FIG. 14 (1), when the right cursor 1104 is pressed, a cursor 1330 shifts to the right and a display example is shown in FIG. 14 (2). In the display state shown in FIG. 14 (2), when the left cursor 1103 is pressed, the cursor 1330 shifts to the left and a display example is shown in FIG. 14 (1).

In the display state shown in FIG. 14 (1), when an OK button 1105 in the front panel 1100 is pressed down, the program display unit 1302a notifies the identifier “Channel 1” to the reproduction unit 1302b. In the display state shown in FIG. 14 (2), when an OK button 1105 in the front panel 1100 is pressed down, the program display unit 1302a notifies the identifier “Channel 2” to the reproduction unit 1302b.

Also, the program display unit 1302a regularly stores the displayed program information from the head end 101 in the first storage unit 511 via the POD 504. Generally, it takes time for program information to be loaded from the head end. When the EPG button 1107 in the input unit 513 is pressed down, the program display can be quickly displayed since the program information saved beforehand in the first storage unit 511 is displayed.

The reproduction unit 1302b plays back channels using the received channel identifier. The relationship between the channel identifier and the channel is stored beforehand in the second storage unit 510 as channel information. FIG. 15 is an example of the channel information stored in the second storage unit 510. The channel information is stored in a grid format. A column 1501 holds a channel identifier. A column 1502 holds channel names. A column 1503 holds tuning information. Below, the tuning information includes the frequency, the transfer rate, the coding efficiency and so on, and is a value supplied to a QAM demodulation unit 501. A column 1504 holds program numbers. The program number is a number for identifying the Program Map Table (PMT) prescribed in the MPEG2 specifications. The PMT is described below. Each row 1511 to 1514 is a combination of identifiers, channel names and tuning information for each channel. The row 1511 is a combination in which the identifier is “1”, the channel name is “channel 1”, the frequency is “150 MHz” in the tuning information and the program number is “101”. The reproduction unit 1302b delivers the identifier of the received channel as-is to the service manager in order to reproduction the channel.

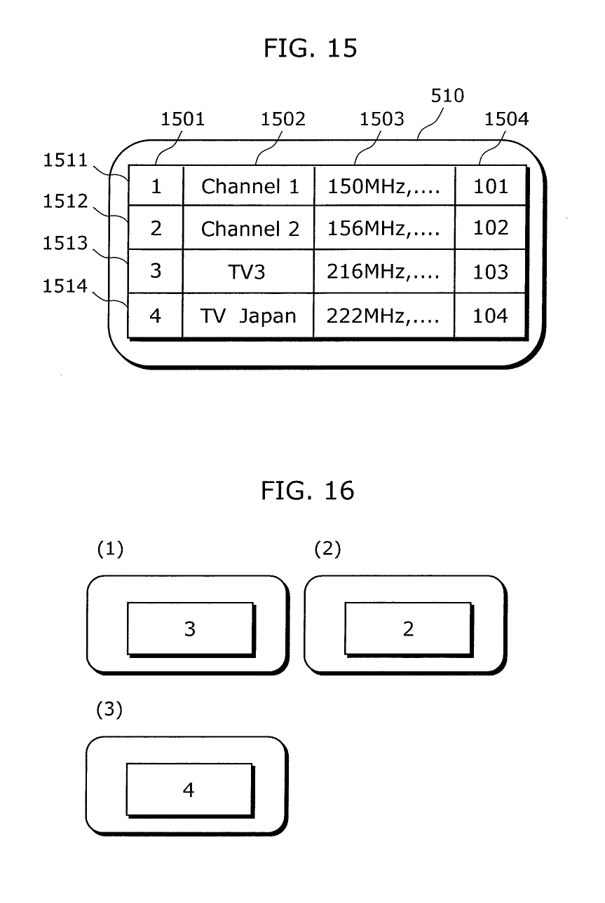

Also, when the user presses down on an upper cursor 1101 and a lower cursor 1102 in the front panel 1100 during reproduction, the reproduction unit 1302b receives the notification pressed from the input unit 513 through the CPU 514 and modifies the channel being played back. First, the reproduction unit 1302b. stores the channel identifier currently being played back in the first storage unit 511. Each of FIGS. 16 (1), (2) and (3) show examples of channel identifiers saved in the first storage unit 511. In FIG. 16 (1), the identifier “3” is stored, and referencing FIG. 15, the channel name “TV 3” is shown as being played back. In the display state shown in FIG. 16 (1), when the user presses the upper cursor 1101, the reproduction unit 1302b references the channel information shown in FIG. 15 and delivers an identifier “2” for the channel name “channel 2” to the service manager since reproduction is switched to the channel with the channel name “channel 2” which is a previous channel in the display. Simultaneously, the channel identifier “2” stored in the first storage unit 511 is re-written. FIG. 16 (2) displays the re-written state of the channel identifier. In the display state shown in FIG. 16 (1), when the user presses the lower cursor 1102, the reproduction unit 1302b references the channel information shown in FIG. 15 and delivers an identifier “4” for the channel name “TV Japan” to the service manager since reproduction is switched to the channel with the channel name “TV Japan2”, which is the next channel in the table. Simultaneously, the channel identifier “4” stored in the first storage unit 511 is re-written. FIG. 16 (3) displays the re-written state of the channel identifier.

The Java™ VM 1303 is a Java™ virtual machine which sequentially analyzes and executes the program recorded in Java™ language. The program written in Java™ language is called a byte code, and is compiled in intermediate code which does not depend on the hardware. The Java™ virtual machine is an interpreter which executes the byte code. Also, a part of the Java™ virtual machine delivers the byte code to the CPU 514 and executes the byte code after translating the byte code into an executable format that the CPU 514 can understand. The Java™ VM 1303 is started up by specifying a Java™ program to be executed by the kernel 1301a. In the present embodiment, the kernel 1301a specifies the server manager 1304 as a Java™ program to be executed. Details of the Java™ language are described in a large amount of documents such as the document “Java™ Language Standard (ISBN 0-201-63451-1)”. Below, these details are omitted. Also, detailed processes of the Java™ VM itself and so on are described in many documents such as the “Java™ Virtual Machine Standard (ISBN -201-63451-X)”. Below, these details are omitted.

The service manager 1304 is a Java™ program written in Java™ language, and is sequentially executed by the Java™ VM 1303. The service manager 1304 can retrieve another program written in Java™ language through the Java™ Native Interface (JNI); otherwise, the other subprogram can be retrieved. JNI is explained in many documents such as the document “Java™ Native Interface”. Below, these details are omitted.

The service manager 1304 receives the channel identifier from the reproduction unit 1302b through the JNI. The service manager 1304 first delivers the channel identifier to the Tuner 1305c which is inside the Java™ library 1305, then requests tuning. The Tuner 1305c references the channel information stored in the second storage unit 510 and acquires tuning information. Now, when the service manager 1304 delivers the channel identifier “2” to the Tuner 1305, the Tuner 1305c acquires the corresponding tuning information “156 Mhz,” by referencing line 1512 in FIG. 15. The Tuner 1305c delivers the tuning information to the QAM demodulation unit 501 through the library 1301b in the OS 1301. The QAM demodulation unit 501 demodulates the signal transmitted from the head end 101 according to the tuning information supplied and delivers the signal to the POD 504.

Next, the service manager 1304 requests that the Conditional Access (CA) in the Java™ library 1305 be descrambled. The CA 1305 supplies information necessary for decrypting to the POD 504 through the library 1301b in the OS 1301. The POD 504 decodes the signal supplied from the QAM demodulation unit 501 based on the supplied information and delivers the signal to the TS decoder 505.

Next, the service manager 1304 supplies the channel identifier to a Java™ Media Framework (JMF) 1305a in the Java™ library 1305 and requests video or audio reproduction.

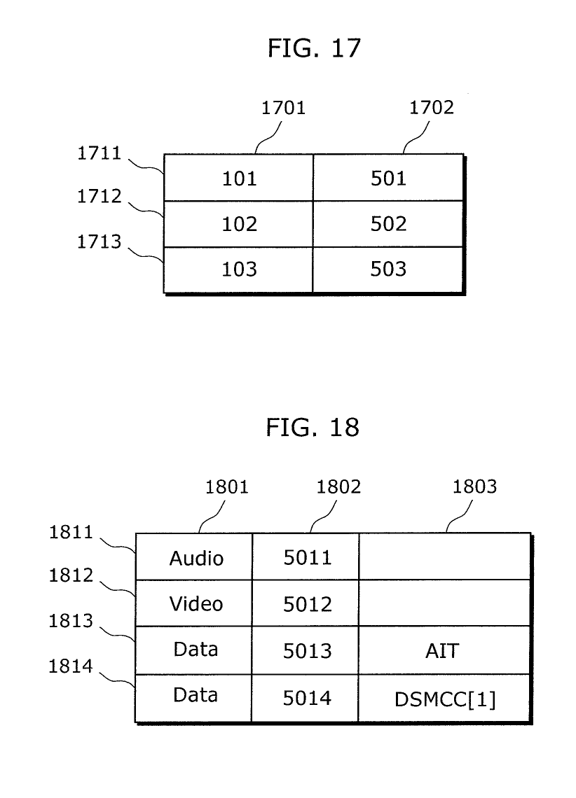

First, the JMF 1305a acquires a packet ID for specifying the video and audio to be played back from the Program Association Table (PAT) and the PMT. PAT and PMT are specified by the MPEG2 specifications and are tables which display the program structure in the MPEG2 transport stream, embedded in the packet payload in the MPEG2 transport stream, and transmitted with the audio and video. The PAT is stored in a packet with the packet ID “0” and transmitted. The JMF 1305a specifies the packet ID “0” and the CPU 514 in the TS decoder 505 through the library 1301b in the OS 1301 in order to acquire the PAT. The TS decoder 505 performs filtering with the packet ID “0” and the JMF 1305a collects PAT packets by delivering packets to the CPU 514. FIG. 17 is a table which shows a typical example of collected PAT information. The column 1701 holds program numbers. The column 1702 holds packet IDs. The packet ID in the column 1702 is used for acquiring the PMT. Rows 1711 to 1713 are a combination of Packet IDs which correspond with the channel program number. Below, these three channels are defined. A combination of the program number “101” and a packet ID “501” is defined in the row 1711. Here, when the channel identifier supplied to the JMF 1305a is “2”, the JMF 1305a acquires the corresponding program number “102” by referencing the row 1512 in FIG. 15 and next acquires the packet ID “502” corresponding to the program number “102” by referencing the PAT row 1712 in FIG. 17.

The PMT is stored and transmitted in the packet ID packet defined in the PAT. The JMF 1305a specifies the packet ID and the CPU 514 in the TS decoder 505 through the library 1301b in the OS 1301 in order to acquire the PMT. Below, the packet ID specified is “502”. The TS decoder 505 performs filtering with the packet ID “502” and the IMF 1305a collects PMT packets by delivering packets to the CPU 514. FIG. 18 is a table which shows a typical example of collected PAT information. The column 1801 holds stream types. The column 1802 holds packet IDs. In the packet with the packet ID specified in the column 1802, the information specified by stream type is stored in the payload and transmitted. The column 1803 holds additional information. Rows 1811 through 1814 are called elementary streams, and are a combination of information types transmitted with the packet IDs. The row 1811 is a combination of the stream type “audio” and the packet ID “5011”, and illustrates that audio is stored in the payload of the packet ID “5011”. The JMF 1305a acquires a packet ID from the PMT of video and audio to be played back. The JMF 1305a acquires the audio packet ID “5011” from the row 1811 and the video packet ID “5012” from the row 1812 by referencing FIG. 18.

Next, the JMF 1305a supplies a combination of the acquired audio packet ID, the audio decoder 506 as an output destination, the video packet ID and the video decoder 508 as an output destination through the library 1301b in the OS 1301 to the TS decoder 505. The TS decoder 505 performs filtering based on the packet ID and the output destination supplied. Below, the packet corresponding to the packet ID “5011” is delivered to the audio decoder 506, and the packet corresponding to the packet ID “5012” is delivered to the video decoder 508. The audio decoder 506 plays back audio through the speaker 507 by performing digital-analogue conversions on the packet supplied. The video decoder 508 connects video data embedded in the packet supplied and outputs the video to the display synthesis unit 515.

Lastly, the service manager 1304 supplies the channel identifier to the AM 1305b in the Java™ library 1305 and requests data broadcast reproduction. Below, data broadcast reproduction extracts the Java™ program included in the MPEG2 transport stream and executes the Java™ program in the Java™ VM 1303. The method which embeds the Java™ program in the MPEG2 transport stream uses a DSMCC protocol described in the MPEG specification ISO/IEC 13818. The DSMCC protocol defines a method for encoding a file system, made up of directories and files used in a computer, among packets in the MPEG2 transport stream. Also, the Java™ program information to be executed is in a format known as an Application Information Table (AIT), which is embedded and transmitted in the packets in the MPEG2 transport stream. The AIT is defined in Chapter 10 of the DVB-MHP specification (formally, ETSI TS 101 812 DVB-MHP specification 1.0.2).

The AM1305b first acquires the AIT, obtains the PAT and PMT of the JMF 1305a in the same way and acquires the packet ID of packets stored in the AIT. Here, the identifier of the supplied channel identifier is “2” and when the PAT in FIG. 17 and the PMT in FIG. 18 is transmitted, the PMT in FIG. 18 is acquired in the same sequence as JMF 1305a. The AM 1305b extracts a packet ID from the elementary stream with an “AIT” as additional information and in which the stream type from the PMT is “data”. As shown in FIG. 18, 1813 applies to the elementary stream in the row and the packet ID “5013” is acquired.

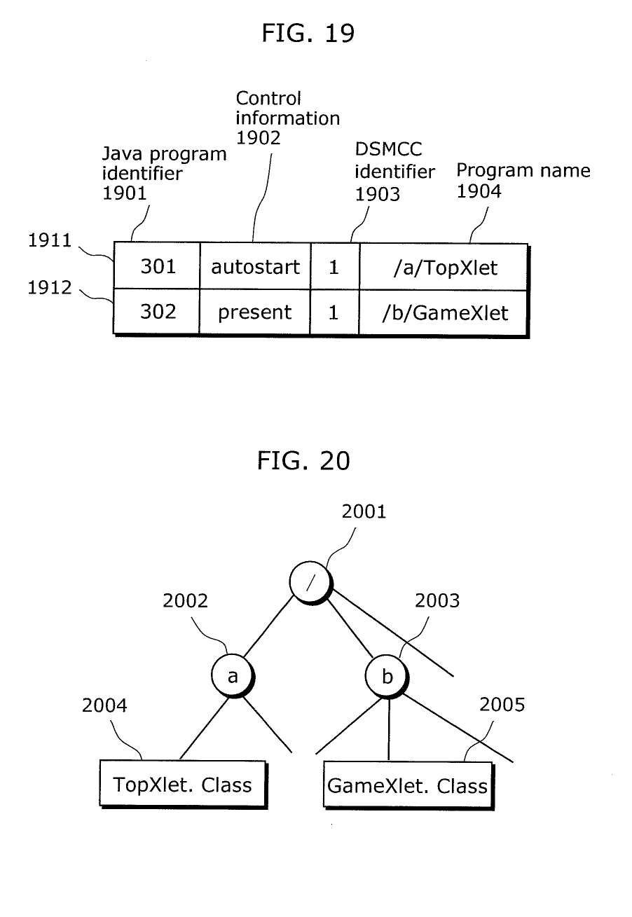

The AM 1305b supplies the AIT packet ID and the output destination to the TS decoder 505 through the library 1301b in the OS 1301. The TS decoder 505 performs filtering with the packet ID supplied and delivers the packet ID to the CPU 514. As a result, the AM 1305b can acquire the AIT packet. FIG. 19 is a table in which a typical example of acquired AIT information is illustrated. The column 1901 holds identifiers for the Java™ program. The column 1902 holds control information for the Java™ program. In the control information there are commands such as “autostart”, “present” and “kill”; “autostart” meaning that the terminal device 500 immediately and automatically executes the program, “present” meaning that the terminal device 500 does not automatically execute the program and “kill” meaning that the program stops. The column 1903 is a DSMCC identifier for extracting the packet ID which includes the Java™ program in the DSMCC protocol. The column 1904 holds program names of the Java™ programs. The row 1911 and 1912 hold a combination of Java™ program information. The Java™ program defined in the row 1911 is a combination of an identifier “301”, “autostart” control information, a DSMCC identifier “1” and the program name “a/TopXlet”. The Java™ program defined in row 1912 is a combination of the identifier “302”, the control information “present”, the DSMCC identifier “1” and the program name “b/GameXlet”. Here, the two Java™ programs have DSMC identifiers, however this indicates that two Java™ programs are included inside the file system which is encoded by a single DSMCC protocol. Here, although only four pieces of information are defined for the Java™ program, more pieces of information are actually defined for the Java™ program. For details, please reference the DVB-MHP specification.

The AM 1305b finds the “autostart” Java™ program among the AITs and extracts the corresponding DSMCC identifier as well as the name of the Java™ program. With reference to FIG. 19, the AM 1305b extracts the Java™ program in row 1911 and acquires the DSMCC identifier “1” and the Java™ program name “a/TopXlet”.

Next, the AM 1305b acquires from the PMT, the packet ID of the packet which stores the Java™ program in the DSMCC protocol using the DSMCC identifier acquired from the AIT. More specifically, the stream type in the PMT is “data”, and the DSMCC identifier in the additional information acquires the packet ID of the compliant elementary stream.

Here, the DSMCC identifier is “1”and when the PMT has the content shown in FIG. 18, the elementary stream in the row 1814 is compliant, and the packet ID “5014” is obtained.

The AM 1305b specifies, through the library 1301b in the OS 1301, the packet ID of the packet in the TS decoder 505 in which data in the DSMCC protocol is embedded, and specifies the CPU 514 as the output destination. Below, the packet ID “5014” is supplied. The TS decoder 505 performs filtering with the supplied packet ID and delivers the packet ID to the CPU 514. As a result, the AM 1305b can accumulate the necessary packets. The AM 1305b restores the file system according to the DSMCC protocol from the acquired packets, and saves the file system in the first storage unit 511. The process in which data such as the file system from the packet in the MPEG2 transport stream is acquired, and saved in a storage unit such as the first storage unit 511 is called downloading below.

FIG. 20 is an example of a downloaded file system. In the figure, circles stand for directories and rectangles stand for files. Here, a root directory 2001, a directory “a” 2002, a directory “b” 2003 are shown as directories, and a “TopXlet.class” 2004 file and a “GameXlet.class” 2005 are shown as files.

Next, the AM 1305b delivers the Java™ program, which is executed from the file system downloaded by the first storage unit 511, to the Java™ VM 1303. Here, when the name of the Java™ program executed is “a/TopXlet”, files with “.class” attached at the end of their Java™ program names are files to be executed. “/” is a division for directory and file names, and referencing FIG. 20, the file 2004 is a Java™ program which must be executed. Next, the AM 1305 delivers the File 2004 to the Java™ VM 1303.

The Java™ program executed by the AM 1305b can also be displayed in the screen by issuing an instruction for rendering an image, text and so on using a Graphics 1305f.

The Graphics 1305f performs rendering of images, text and so on by issuing a rendering instruction through the CPU 514, which is a rendering command obtained by the Java™ program, to the OSD control unit 515. Also, the alpha value can be set for each rendering process or each pixel through the Graphics 1305f in the Java™ program. A result in which each rendering process is alpha-synthesized is outputted to the graphics buffer 1202. Also, when the Java™ program can set the alpha value according to input from the user, of course an alpha value can be set for each pixel or each rendering process.

The Java™ VM1303 executes the delivered Java™ program.

When the service manager 1304 receives an identifier for another channel, video and audio reproduction as well as execution of the Java™ program through each library included in the Java™ library 1305 are stopped similarly via each library included in the Java™ library 1305, and video and audio reproduction as well as execution o the Java™ program are performed based on a newly received channel identifier.

The Java™ library 1305 is a collection of Java™ libraries stored in the ROM 512. In the present embodiment, the Java™ library 1305 includes a JMF 1305a, an AM 1305b, a Tuner 1305c, a CA 1305d, a POD Lib 1305e, a Graphics 1305f and so on.

Next, a Java™ program that includes a mail function is used to explain graphics transparency control according to the present invention.

The service manager 1304 performs two-way communication with the head end 101 through the POD Lib 1305e which is included in the Java™ library 1305. The two-way communication is realized by the POD Lib 1305e using the QPSK demodulation unit 502 and the QPSK modulation unit 503 via the library 1301b in the OS 1301 and the POD 504.

The service manager 1304 receives Java™ program information which must be saved by the terminal device 500 in the second storage unit 510 from the head end 101 using two-way communication. This information is called XAIT information. XAIT information is transmitted between the head end 101 and the POD 504 in an arbitrary format.

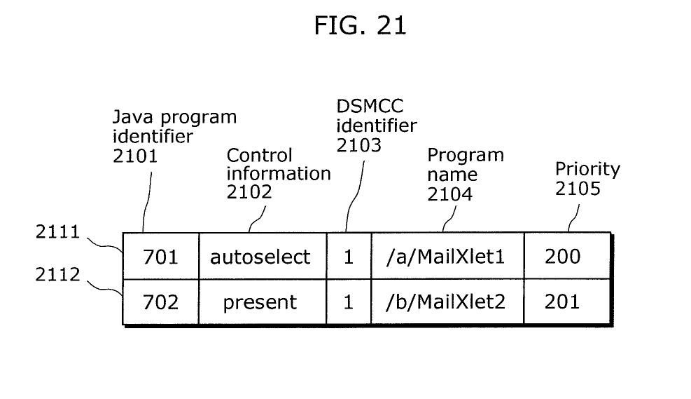

FIG. 21 is a table which displays a typical example of XAIT information obtained from the head end 101. A column 2101 holds identifiers for the Java™ programs. A column 2102 holds control information for the Java™ programs. “autoselect”, “present” and so on are included in the control information; “autoselect” meaning that the program automatically executes when the terminal device 500 is powered on, and “present” meaning that the program does not automatically execute. A column 2103 holds DSMCC identifiers for extracting the packet ID which includes the Java™ program in the DSMCC protocol. A column 2104 holds program names of the Java™ programs. A column 2105 holds the priorities of the Java™ programs. The rows 2111 and 2112 are a combination of information about the Java™ programs. The Java™ program defined in the row 2111 is a combination of the identifier “701”, the control information “autoselect”, the DSMCC identifier “1” and the program name “a/MailXlet1”.

When the service manager 1304 receives the XAIT information, the file system from the MPEG2 transport stream is saved in the first storage unit 511 in the same order as the order in which the Java™ program is downloaded from the AITI information. Subsequently, the saved file system is reproduced in the second storage unit 510. Note that the file system can be downloaded to the second recording unit 510 without passing through the first storage unit 511. Next, the service manager 1304 associates the storage position of the downloaded file system with the XAIT information and saves the file system in the second storage unit.

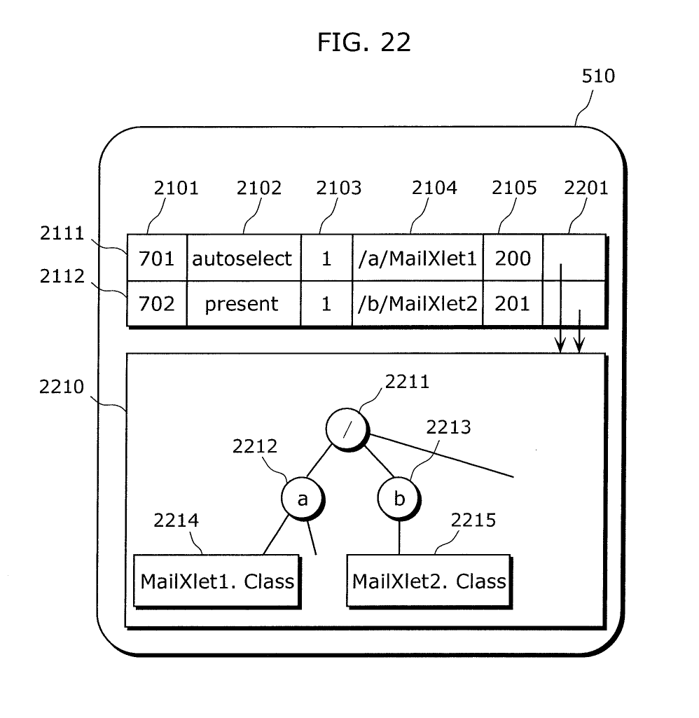

FIG. 22 illustrates an example in which XAIT information and the downloaded file system 2210 are associated and saved by the secondary storage unit 510. In the figure, the same numbered elements as FIG. 21 and the same numbers as FIG. 21 are attached; these explanations are omitted. The column 2201 in the XAIT information stores the saved position of the corresponding downloaded file system 2210. In the figure, the saved position is shown with arrows. A top directory 2211, a directory “a” 2212, a directory “b” 2213, a file “MailXlet1.class” 2214 and a file “MailXlet2.class” 2215 are included in the downloaded file system 2210. Note that the XAIT information is saved after the Java™ program is stored, however the XAIT information may be saved before saving the Java™ program.

After the terminal device 500 is powered on, the OS 1301 specifies the service manager 1304 for the Java™ VM 1303 and the Java™ VM 1303 starts up the service manager 1304. Subsequently, the service manager 1304 references the XAIT information saved initially in the second storage unit 510. Here, the “autoselect” program is delivered to the Java™ VM 1303 and started up by referencing control information for the Java™ program. As shown in FIG. 22, the Java™ program “Mail Xlet1” defined in the row 2111 is started up. Below, since the Java™ program described in AIT depends on the tuning, when another channel is selected by the user, the Java™ program that is started up may stop, however, since the Java™ program described in the XAIT information differs from the Java™ program described in AIT in not depending on the tuning, once the Java™ program is started up it will not stop unless it is deliberately stopped.

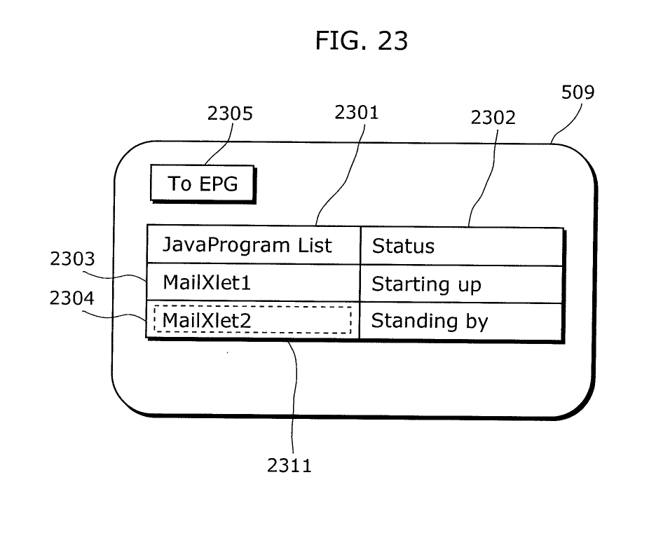

Also, a Java™ program which is not automatically executed by “autoselect” can be executed selecting from the program display unit 1302a. Along with displaying normal programs, the program display unit 1302a can show a list of executable Java™ programs. An example display of the program display unit 1302a which displays the list of executable Java™ programs is shown in FIG. 23. In FIG. 23, the column 2301 holds the list of Java™ programs and the column 2302 holds the current state of each Java™ program. The row 2303 shows the state which corresponds to the Java™ program “MailXlet1”, and row 2304 shows the state which corresponds to the Java™ program “MailXlet2”. In 2311, a cursor is displayed; when an OK button 1105 is pressed by the user, the application indicated by the cursor 2311 is executed while in “stand by”. Also, when the Java™ program is “executing”, the Java™ program will enter a display state even when the Java™ program is in a non-display state. When in a non-display state, nothing happens. The button 2305 is a button for returning to a normal EPG image, for example an image displayed in FIG. 14 (1).

Below, the “MailXlet1” program is a Java™ program which perform sending and receiving mail. The Java™ program “MailXlet1” is realized by performing two-way communication with the head end 101 through the POD Lib1305e included in the Java™ library 1305.

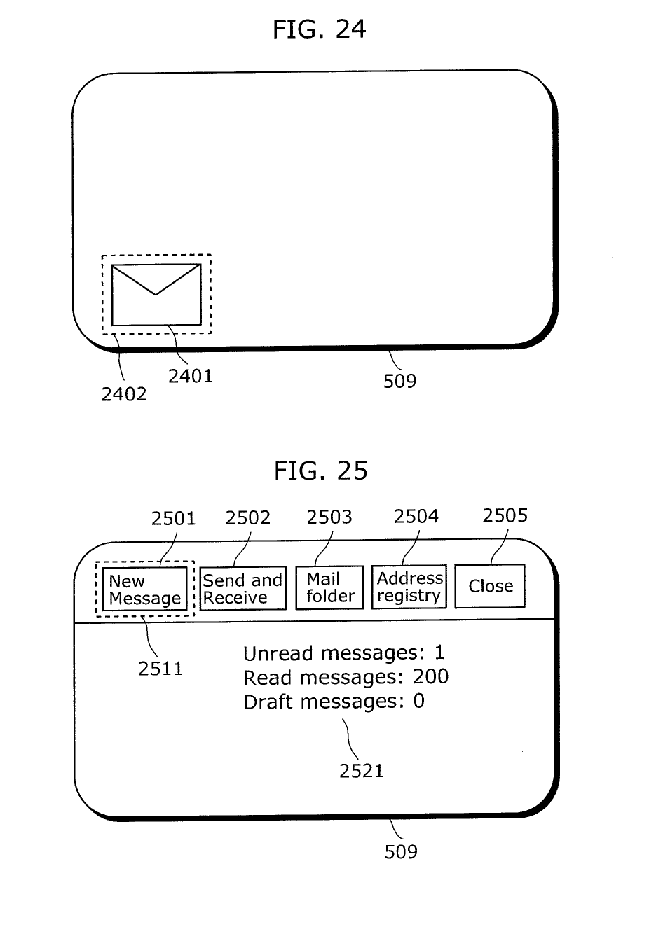

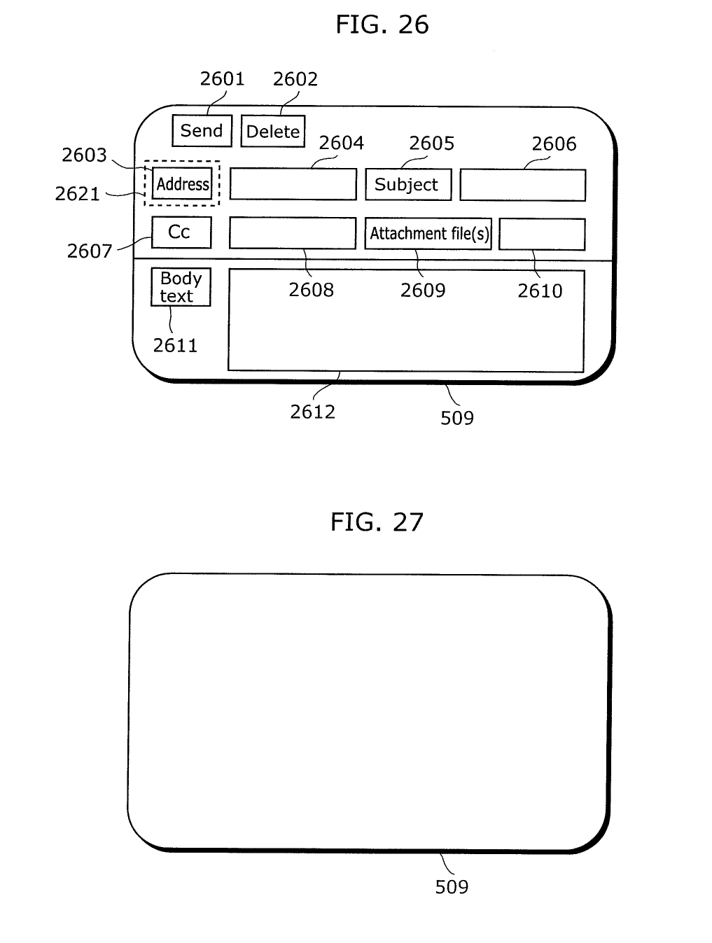

When the Java™ program “MailXlet1” is started up, the envelope image (icon) 2401 is displayed on the screen and the Java™ program enters a state of waiting for the user's selection as shown in FIG. 24. In FIG. 24, an example of the screen display in which the icon 2401 and the cursor 2402 are displayed in the Java™ program “MailXlet1” are shown. In this state, when the user presses the OK button 1105, the Java™ program “MailXlet1” displays the main screen shown in FIG. 25. A “New Message” button 2501 which composes a mail, a “Send and Receive” button 2502 which performs sending and receiving of mail, a “mail folder” button 2503 which shifts the mail folder screen, an “address registration” button 2504 which shifts the address registration screen, and a “close” button 2505 which closes the screen are shown in the main screen. Also, the cursor 2511 is displayed at the location of the “New Message” button 2501. The cursor 2511 shifts to the “Send and Receive” button 2502 and the “mail folder” button 2503 by pressing the left cursor button 1103 and the right cursor button 1104. Further, information 2521 which shows a summary of the mail send and receive state is displayed in the main screen. For example, as shown in FIG. 25, when the cursor 2511 is on the “compose” button 2501 and the OK button 1105 is pressed, the compose screen diagram shown in FIG. 26 can be transitioned to.

As shown in FIG. 26, the compose screen diagram is made up of a cursor 2621, a “Send” button 2601 which sends mail, a “Delete” button 2602 which deletes mail, a “To:” button 2603 in which the addressee is inputted, an addressee input box 2604 which inputs the addressee when the cursor 2621 is on the “To:” button 2603 and the OK button 1105 is pressed, a “Subject” button 2605 which inputs a subject for the mail, a subject input box 2606 which inputs the subject when the OK button 1105 is pressed, a “Cc” button 2607 which inputs a Cc for the mail addressee (carbon copy), a Cc input box 2608 which inputs the Cc for the mail address when the cursor 2621 is on the “Cc” button 2607 and the OK button 1105 is pressed, an “Attach file” button 2609 which adds an attachment file to the mail, an attached file display box 2610 which shows the content of the attached file added when the cursor 2621 is on the “Attachment file” button 2605 and the OK button 1105 is pressed, a “body text” button 2611 in which the body of the mail is inputted, and a body text input box 2612 in which the body of the mail is inputted when the cursor 2621 is on the “Body text” button 2611 and the OK button 1105 is pressed. When the cursor 2621 is on the “send” button 2601 or the “delete” button 2603 and the OK button 1105 is pressed by the user, the present mail is sent or deleted respectively and the Java™ program transitions to the main screen shown in FIG. 25.

In the main screen shown in FIG. 25, when the cursor 2511 is on the “Close” button 2505 and the OK button 1105 is pressed by the user, the Java™ program transitions to a screen in which nothing is displayed as graphics, as shown in FIG. 27. In the display state shown in the FIG. 27, the Java™ program “MailXlet1” regularly performs two-way communication with the head end 101 through the POD Lib 1305e which is included in the Java™ library 1305, and checks for newly received mail. When newly received mail is found, the Java™ program “MailXlet1” notifies the user that new mail has been received by displaying the screen shown in FIG. 24 again and using an icon 2401.

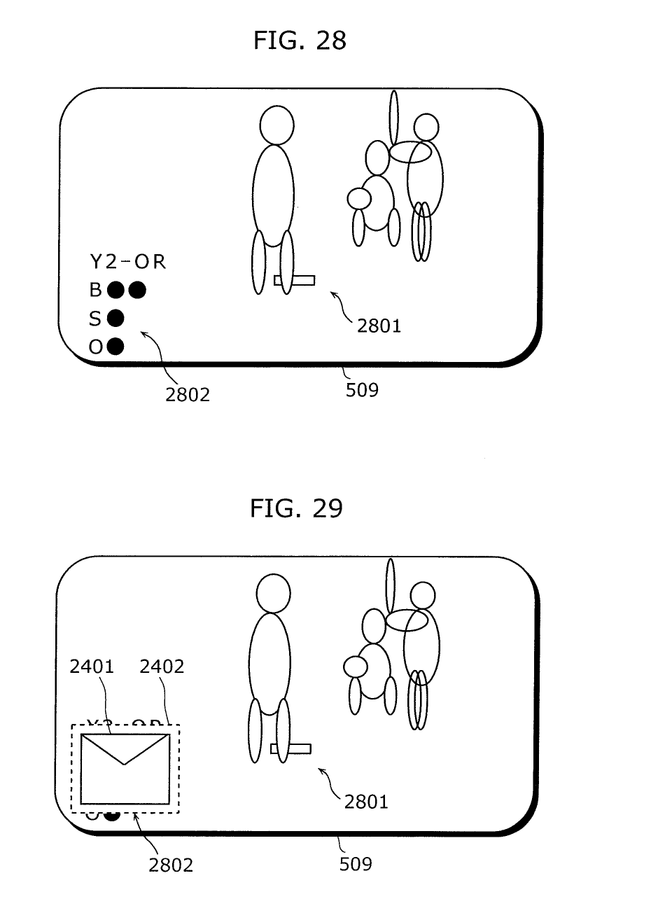

Now, the Java™ program “MailXlet1” is in the display state shown in FIG. 27, and a program “baseball (Y vs. R)”, which is a baseball game, is broadcast. FIG. 28 shows an example of a display screen in this situation, and displays a state in which a video showing “Baseball (Y vs. R)” is shown. A part of the main video 2801 and additional information (here, the current batter count, the out count are the current score) 2802 included in the video are shown in FIG. 28.

Next, at a certain timing, when the Java™ program “MailXlet1” receives a new mail, normally the new mail is displayed as if it were the screen example shown in FIG. 29. In the FIG. 29, the additional information 2802 included in the video is covered by the icon 2401 which indicates that the mail is received and the display is obscured. In other words, the additional information 2802 displayed in the screen shown in FIG. 28 is obscured.

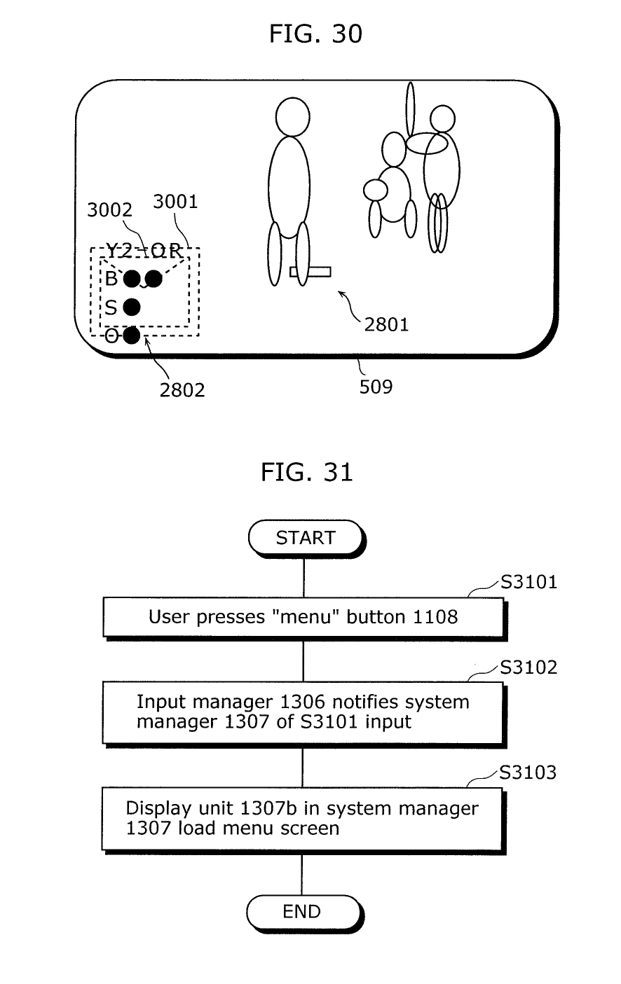

The user may want to know that a mail is received without the additional information 2802 being obscured. In other words, as shown in FIG. 30, the user may want to view both all video included in the broadcast and the mail received notification (graphics) at the same time. In FIG. 30, in addition to the additional information 2802 in the video, when the icon 2401 which shows that mail has been received is displayed translucently (as the Icon 3001), the cursor 2402 is displayed translucently (as the cursor 3002). According to the present invention, it is possible to alpha synthesize and display the user's preference, in other words graphics and video, at a ratio preferred by the user. Below, a method for realizing the display is explained.

First, the user assembles a display unit 1307b for the system manager 1307 by pressing the menu button 1108 shown in FIG. 11 in order to set the display-merged screen as shown in FIG. 30. FIG. 31 is a flowchart which shows the sequence in this case.

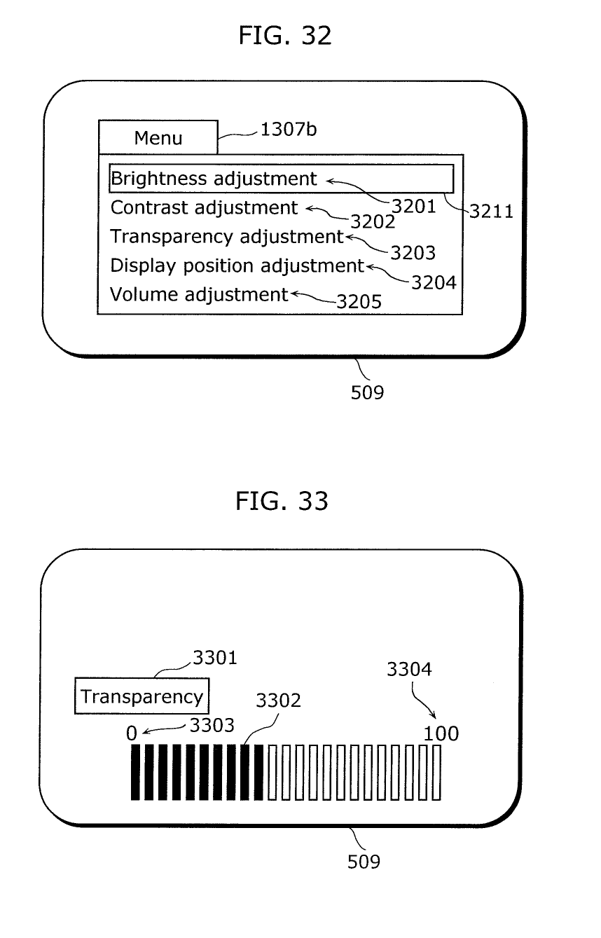

When the user presses the menu button (S3101), the input manager 1306 notifies the system manager 1307 of the input (S3102). When the display unit 1307b in the system manager 1307 receives the input from the menu button 1108, the menu image as shown in FIG. 32 is loaded (S3103).

As shown in FIG. 32, the menu screen 1307b is made up of a variety of settings screens. Here, menu items such as a screen brightness adjustment 3201, a screen contrast adjustment 3202, a graphics transparency adjustment 3203, a screen display position adjustment 3204, a volume adjustment 3205, and a cursor 3211 are shown. Each adjustment function in FIG. 32 is selected by the user pressing the upper cursor button 1101 or the lower cursor button 1102 and pressing the OK button 1105 according to the corresponding adjustment position.

For example, when adjusting graphics transparency, the user can transition to the transparency adjustment screen shown in FIG. 33 by lining up the cursor 3211 at the top of the “transparency adjustment” 3203 and pressing the OK button 1105. In FIG. 33, the adjustment item 3301, the gradation of the adjustment ratio (“0%” for 3303 and “100%” for 3304) and the adjustment bar 3302 are shown. The current adjustment level (about 40% for the example in the figure) is shown by the colored-in and empty oblong rectangles arranged length-wise. The transparency can be adjusted by pressing the left cursor button 1103 or the right cursor button 1104. When the adjustment is finished, it is finished by pressing the OK button 1105 and the adjusted transparency is reflected.

Note that the transparency set here in the present embodiment is a correction coefficient held in the correction coefficient holding unit 1201, in other words, corresponding to a coefficient by which the alpha value of the graphics is multiplied. Accordingly, for example when the transparency is 100%, this means that the alpha value held in the graphics buffer 1202 is used as-is to output the graphics, and when the transparency is 50%, this means that the alpha value held in the graphics buffer 1202 is halved (increasing the transparency) and the graphics are outputted.

Also, acquiring the storage and correction coefficient of the alpha value for the graphics buffer 1202 and processing, for instance, storing the correction coefficient in the correction coefficient holding unit 1201 may be realized by a circuit, a program or the like which are provided beforehand by the terminal device 500, and by the application program (such as a Java™ program) downloaded from the broadcast signal.

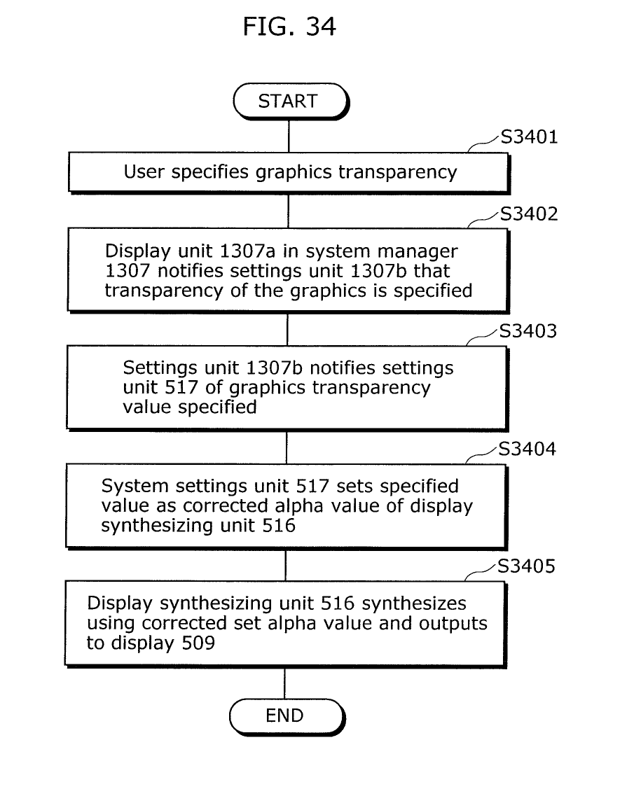

FIG. 34 is a flowchart which shows the sequence when the transparency set by the transparency adjustment screen shown in FIG. 33 is reflected. First, the user specifies the transparency in the transparency adjustment window screen shown in FIG. 33 (S3401). Then, the display unit 1307b in the system manager 1307 notifies the settings unit 1307a that the transparency has been specified by the user as well as the specified transparency (S3402). The settings unit 1307a notifies the system settings unit 517 that the graphics transparency has been specified as well as the specified transparency through the CPU 514 shown in FIG. 5 (S3403). The system settings unit 517 stores the specified transparency as a correction coefficient in the correction coefficient holding unit 1201 of the display synthesis unit 516 (S3404). The display synthesis unit 516 corrects the alpha value for the graphics using the correction coefficient stored in the correction coefficient holding unit 1201, performs alpha blending of the graphics, video and background using the corrected alpha value and outputs the result to the display (S3405).

The user can freely set the transparency of the graphics by the above methods, and can simultaneously read out the information that displays the graphics and the video. For example, the screen display shown in FIG. 30 can be obtained by setting the transparency adjustment image at 50% transparency, such that the transparency normally becomes as shown in FIG. 29 since the alpha value held in the graphics buffer 1202 is 1.0 (completely non-transparent, in other words, a setting for covering video with graphics). Thus, the user can view the video and the graphics simultaneously and a feeling of discomfort for the user is avoided.

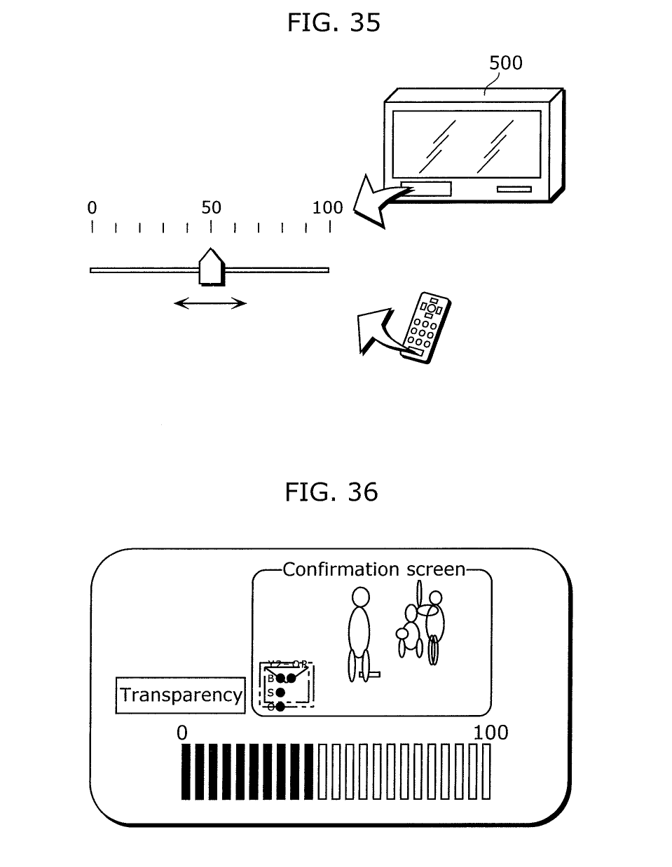

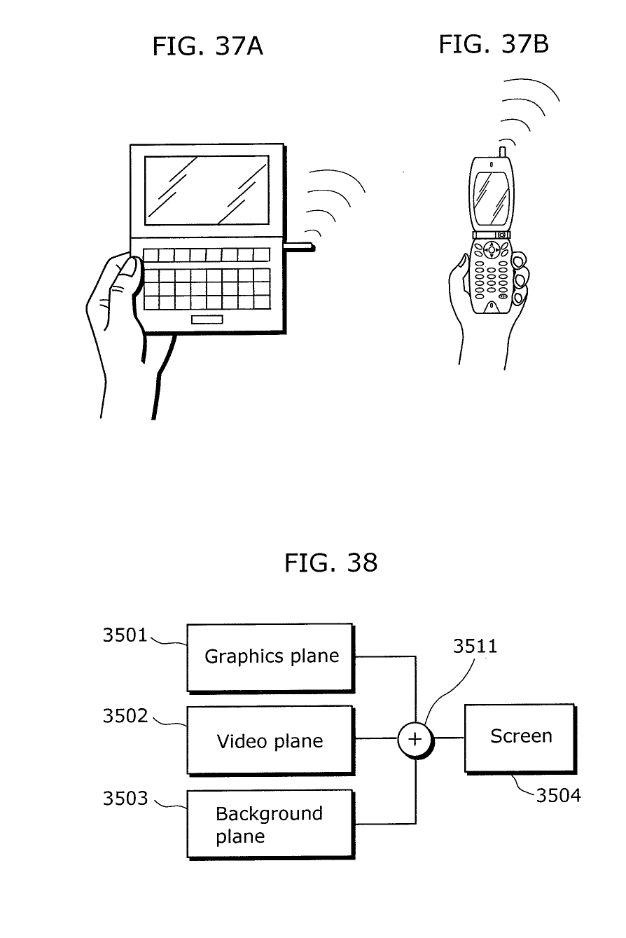

Above, the digital television according to the present invention is explained based on the embodiment, however the present invention is not limited to the embodiment. For example, in the present embodiment, a menu screen such as the one in FIG. 32 is used in order to adjust the transparency, however as shown in FIG. 35, adjustments to the transparency may be realized by installing a button which adjusts the transparency on the front panel or the remote control of the terminal device 500.

Also, in the present embodiment, functions for adjusting the transparency in stages are explained, however a setting may be installed for turning the graphics ON or OFF. Otherwise, the present invention may simply include only an ON/OFF function for the graphics without holding an adjustment function in stages.

Also, the present invention may set a different transparency for each pixel in the screen or for every range instead of setting a single transparency for all of the graphics.

Also, the specific example in the present embodiment is a synthesized example of the graphics and the video, however the user can freely adjust the transparency of the graphics with the same method, for the graphics and the background, or the graphics, video and background.

Also, in the present embodiment, as shown in FIG. 33, in the transparency adjustment screen, only the adjustment bar 3302 is displayed, however as shown in FIG. 36, a confirmation screen for confirming the transparency at this point is simultaneously displayed in addition to the adjustment bar 3302. This, for example, can be realized by displaying the images shown in FIG. 30 as reduced images, and fixed video, graphics, alpha-synthesized images and so on for adjustment inside the transparency adjustment screen.

Also, although in the present embodiment, the image synthesis method according to the present invention is applied as an example to digital television, the image synthesis method can be applied to a device which synthesizes and displays graphics, video and so on, for example, an information terminal, a cellular information terminal, a cellular phone and so on which can receive television broadcasts or digital video

### INDUSTRIAL APPLICABILITY

The present invention can be used as a digital television and so on which synthesizes and displays graphics, video and so on, for example, an information terminal, a cellular information terminal, a cellular phone and so on which can receive home digital television, television broadcasts or digital video distribution, and especially as a display device which displays merged contents according to the preference of the user.

1. A digital television which synthesizes video data and graphics data generated by an application, comprising:
a graphics data holding unit operable to hold a value set according to the graphics data and a request from the application, the value being an alpha value that indicates a synthesis ratio for the graphics data;
a video data holding unit operable to hold video data;
a transparency obtainment unit operable to obtain from a viewer of the digital television a specification for a transparency which is specified at a ratio at which graphics data and video data are synthesized;
a synthesis unit operable to synthesize the graphics data held in said graphics data holding unit and the video data held in said video data holding unit according to the obtained transparency, and to output the synthesized data at a synthesis ratio, the synthesis ration being a corrected alpha value obtained by multiplying the alpha value by a correction coefficient for the alpha value, which is equal to the transparency obtained by said transparency obtainment unit; and
a display unit operable to display the graphics data and the video data synthesized by said synthesis unit.

2. (canceled)

3. The digital television according to claim 1, further comprising
a downloading unit operable to download a program from outside;
wherein the alpha value is stored in said graphics holding unit according to a first program downloaded by said downloading unit.

4. The digital television according to claim 3,
wherein the obtainment of the transparency by said transparency obtainment unit is performed by executing a second program downloaded by said downloading unit.

5. The digital television according to claim 1,
wherein said synthesis unit is operable to synthesize according to the Porter-Duff rule.

6. The digital television according to claim 1, further comprising
a background data holding unit operable to hold background data which shows a background image; and
said synthesis unit is operable to synthesize the background data held in said background data holding unit, in addition to the graphics data and the video data.

7. The digital television according to claim 6, comprising
at least one of
said graphics data holding unit,
said video data holding unit, and
said background data holding unit,
as a plurality.

8. An image synthesis method for synthesizing video data and graphics data generated by an application in a digital television, comprising:
a graphics data holding step for holding a value set according to the graphics data and a request from the application, the value being an alpha value that indicates a synthesis ratio for the graphics data;
a video data holding step for holding video data;
a transparency obtainment step for obtaining from a viewer of the digital television a specification for a transparency which is specified at a ratio at which graphics data and video data are synthesized; and
a synthesis step for synthesizing the graphics data held in said graphics data holding step and the video data held in said video data holding step according to the obtained transparency, and to output the synthesized data at a synthesis ratio, the synthesis ration being a corrected alpha value obtained by multiplying the alpha value by a correction coefficient for the alpha value, which is equal to the transparency obtained by said transparency obtainment unit; and
a display step for displaying the graphics data and the video data synthesized by said synthesis step.

9. A program for a digital television which synthesizes and displays graphics data and video data, said program causing a computer to execute the steps included in the image synthesis method according to claim 8.
